(19) United States
(12) Patent Application Publication
(10) Pub. No.: US 2025/0391341 A1
(43) Pub. Date: Dec. 25, 2025

(54) RAMP DRIVER, AND WEARABLE ELECTRONIC DEVICE

(71) Applicants: Samsung Display Co., Ltd., Yongin-si (KR); IUCF-HYU (Industry-University Cooperation Foundation Hanyang University), Seoul (KR)

(72) Inventors: Byung Chang YU, Yongin-si (KR); Kyung Hoon CHUNG, Yongin-si (KR); Oh Kyong KWON, Seoul (KR); Youn Sik KIM, Seoul (KR); Sung Min WEE, Seoul (KR)

(21) Appl. No.: 19/209,661

(22) Filed: May 15, 2025

(30) Foreign Application Priority Data
Jun. 21, 2024 (KR) 10-2024-0081217
Aug. 8, 2024 (KR) 10-2024-0106081

(51) Int. Cl. G09G 3/32; G09G 3/02; G09G 3/3233

(52) U.S. Cl. CPC G09G 3/32; G09G 3/02; G09G 3/3233; G09G 2300/0819; G09G 2310/066; G09G 2310/08; G09G 2320/045

(57) ABSTRACT

A ramp driver includes: a ramp generator to generate a reference ramp signal, and including a resistor string including: a first end to receive a high ramp voltage; and a second end to receive a low ramp voltage; and a ramp delayer to sequentially output the reference ramp signal. The ramp generator is to: divide the high ramp voltage into first through k-th voltages by utilizing the resistor string; and sequentially output the first through k-th voltages to generate the reference ramp signal, where k is a positive integer.

### CROSS-REFERENCE TO RELATED PATENT APPLICATION

This application claims priority to and the benefit of Korean Patent Application No. 10-2024-0081217, filed on Jun. 21, 2024, and Korean Patent Application No. 10-2024-0106081, filed on Aug. 8, 2024, in the Korean Intellectual Property Office, the entire disclosure of each of which is incorporated by reference herein.

### BACKGROUND OF THE INVENTION

### 1. Field

The present disclosure relates to a ramp driver, and wearable electronic

device. More specifically, the present disclosure relates to a ramp driver for providing a ramp signal to a subpixel and a display device including the same.

### 2. Description of the Related Art

As information technology develops, importance of a display device which is a connecting medium between a user and information is emphasized. In response to this, using of a display device such as a liquid crystal display device, an organic light emitting display device, and an inorganic light emitting display device is increasing.

Recently, research on a micro light emitting diode (LED) which may achieve faster response speed and higher brightness compared to a conventional LED is actively conducted.

The above information disclosed in this Background section is for enhancement of understanding of the background of the present disclosure, and therefore, it may contain information that does not constitute prior art.

### SUMMARY

When using a pixel driving scheme of a pulse amplitude modulation (PAM) as in an organic LED, an inorganic light emitting element, such as the micro LED, may have difficulty in accurately realizing an intended brightness, as a center wavelength of a current may shift with a current density. Thus, the micro LED may use a pixel driving scheme of a pulse width modulation (PWM), which represents a brightness, by controlling a time during which the current flows to the light emitting element.

One or more embodiments of the present disclosure may be directed to a ramp driver for generating a ramp signal.

One or more embodiments of the present disclosure may be directed to a display device including a ramp driver.

According to one or more embodiments of the present disclosure, a ramp driver includes: a ramp generator configured to generate a reference ramp signal, and including a resistor string including: a first end configured to receive a high ramp voltage; and a second end configured to receive a low ramp voltage; and a ramp delayer configured to sequentially output the reference ramp signal. The ramp generator is configured to: divide the high ramp voltage into first through k-th voltages by utilizing the resistor string; and sequentially output the first through k-th voltages to generate the reference ramp signal, where k is a positive integer.

In an embodiment, the ramp generator may further include a plurality of stages, each of the stages configured to output at least one of the first through k-th voltages, and including: at least one resistor element of a plurality of resistor elements included in the resistor string; a ramp switch configured to be turned on in response to a ramp control signal, and including a first end connected to the at least one resistor element, and a second end connected to an output end of the ramp generator; and a flip-flop configured to output the ramp control signal.

In an embodiment, the flip-flop of a first stage of the plurality of stages may be configured to receive a vertical start signal, and the flip-flop of a second stage of the plurality of stages may be configured to receive the ramp control signal output from the flip-flop of the first stage.

In an embodiment, the ramp delayer may include a plurality of delay blocks, each including j output ends, where j may be a positive integer greater than or equal to 2.

In an embodiment, each of the delay blocks may include j delay circuits configured to delay an input signal, a first delay circuit of the delay circuits of a first delay block among the delay blocks may be configured to receive the reference ramp signal, and a second delay block of the delay blocks may be configured to receive an output signal of a j-th delay circuit of the delay circuits of the first delay block.

In an embodiment, at least one of the delay circuits may include: a first amplifier including a first input end, a second input end, and an output end connected to the second input end; a first delay switch configured to be turned on in response to a gate clock signal, and including a first end connected to an input end of the at least one of the delay circuits, and a second end connected to the first input end of the first amplifier; a second delay switch configured to be turned on in response to the gate clock signal, and including a first end and a second end connected to the second input end of the first amplifier; a sampling capacitor including a first electrode connected to the first input end of the first amplifier, and a second electrode connected to the first end of the second delay switch; a third delay switch configured to be turned on in response to an inverted gate clock signal, and including a first end connected to the input end of the at least one of the delay circuits, and a second end connected to the second electrode of the sampling capacitor; and a fourth delay switch configured to be turned on in response to the inverted gate clock signal, and including a first end connected to the output end of the first amplifier, and a second end connected to an output end of the at least one of the delay circuits.

In an embodiment, the at least one of the delayed circuits may further include a fifth delay switch configured to be turned on in response to the inverted gate clock signal, and including a first electrode connected to the first input end of the first amplifier, and a second electrode connected to the first input end of the first amplifier.

In an embodiment, the gate clock signal may have an activation level in a sampling period, and may have an inactivation voltage level in an output period. The inverted gate clock signal may have an inactivation level in the sampling period, and may have an activation level in the output period.

In an embodiment, each of the delay blocks may include: j delay circuits for delaying an input signal; and an error compensator configured to generate a compensation control signal by comparing an output signal of a first delay circuit of the delay circuits and an output signal of a j-th delay circuit of the delay circuits.

In an embodiment, the error compensator may include: a second amplifier including a first input end, a second input end configured to receive a reference voltage, and an output end; a first capacitor including a first electrode and a second electrode connected to the first input end of the second amplifier; a second capacitor including a first electrode connected to the first input end of the second amplifier, and a second electrode connected to the output end of the second amplifier; a sixth delay switch configured to be turned on in response to a compensation clock signal, and including a first end connected to the first input end of the second amplifier, and a second end connected to the output end of the second amplifier; a seventh delay switch configured to be turned on in response to an inverted compensation clock signal, and including a first end connected to a first input end of the error compensator, and a second end connected to the first electrode of the first capacitor; an eighth delay switch configured to be turned on in response to the compensation clock signal, and including a first end connected to a second input end of the error compensator, and a second end connected to the first electrode of the first capacitor; a ninth delay switch configured to be turned on in response to a gate clock signal, and including a first end connected to the output end of the second amplifier, and a second end connected to an output end of the error compensator; a comparator configured to compare a signal of the first input end of the error compensator and a signal of the second input end of the error compensator to output a comparison signal; a first delay transistor including a control electrode configured to receive the comparison signal, a first electrode configured to receive a first predicted voltage, and a second electrode; a second delay transistor including a control electrode configured to receive the comparison signal, a first electrode configured to receive a second predicted voltage different from the first predicted voltage, and a second electrode; and a tenth delay switch configured to be turned on in response to an inverted gate clock signal, and including a first end connected to the second electrode of the first delay transistor and the second electrode of the second delay transistor, and a second end connected to the output end of the error compensator.

In an embodiment, the first delay transistor may be of a different type from that of the second delay transistor.

In an embodiment, a first delay block of the delay blocks may be configured to generate the compensation control signal, and apply the compensation control signal to a second delay block of the delay blocks. The first delay circuit of the second delay block may be configured to receive the output signal of the j-th delay circuit of the first delay block, and compensate for the output signal of the j-th delay circuit of the first delay block in response to the compensation control signal received from the first delay block.

In an embodiment, the first delay circuit of the second delay block may include: a first amplifier including a first input end, a second input end, and an output end connected to the second input end; a first delay switch configured to be turned on in response to a gate clock signal, and including a first end connected to an input end of the first delay circuit of the second delay block, and a second end connected to the first input end of the first amplifier; and a sampling capacitor including a first electrode connected to the first input end of the first amplifier, and a second electrode configured to receive the compensation control signal.

In an embodiment, the compensation control signal may alternately have a difference of a voltage of the first input end of the error compensator and a voltage of the second input end of the error compensator and a second predicted voltage in a first period, and may alternately have a difference of a voltage of the first input end of the error compensator and a voltage of the second input end of the error compensator and the first predicted voltage in a second period.

According to one or more embodiments of the present disclosure, a ramp driver includes: a ramp generator configured to generate a reference ramp signal; and a ramp delayer configured to sequentially output the reference ramp signal. The ramp generator includes: a plurality of ramp transistors; a first ramp switch configured to be turned on in response to a ramp control signal, and including a first end configured to receive a high ramp voltage, and a second end electrically connected to an output end of the ramp generator; a second ramp switch configured to be turned on in response to an inverted ramp control signal, and including a first end connected to the second end of the first ramp switch, and a second end; and a plurality of third ramp switches, each including a first end connected to the second end of the second ramp switch, and a second end connected to one of the ramp transistors.

In an embodiment, a slope of the reference ramp signal may increase as a channel width of each of the third ramp switches that are turned on increases.

In an embodiment, a channel width of each of the ramp transistors may be different from each other, the reference ramp signal may have a first slope when a first ramp transistor of the ramp transistors is turned on, and the reference ramp signal may have a second slope greater than the first slope when a second ramp transistor having the channel width greater than that of the first ramp transistor among the ramp transistors is turned on.

According to one or more embodiments of the present disclosure, a display device includes: a display panel including a plurality of subpixels; a ramp driver including a ramp generator configured to generate a reference ramp signal, and a ramp delayer configured to sequentially output the reference ramp signal as a ramp signal to pixel rows including the subpixels; a scan driver configured to provide scan signals to the subpixels; a data driver configured to provide data voltages to the subpixels; and a driving controller configured to control the ramp driver, the scan driver, and the data driver. The ramp generator includes a resistor string including a first end configured to receive a high ramp voltage, and a second end configured to receive a low ramp voltage. The ramp generator is configured to: divide the high ramp voltage into first through k-th voltages by utilizing the resistor string; and sequentially output the first through k-th voltages to generate the reference ramp signal, where k is a positive integer.

In an embodiment, the driving controller may be configured to drive the display panel at a driving frequency, the ramp generator may further include a plurality of stages configured to sequentially output the first through k-th voltages at each cycle of a ramp clock signal, and a frequency of the ramp clock signal may be a product of the driving frequency and a number of resistor elements of the resistor string.

In an embodiment, the driving controller may be configured to drive the display panel at a driving frequency, the ramp delayer may include a plurality of delay blocks, each including j output ends, and each of the delay blocks may include j delay circuits configured to delay an input signal. At least one of the delay circuits may include: a first amplifier including a first input end, a second input end, and an output end connected to the second input end; a first delay switch configured to be turned on in response to a gate clock signal, and including a first end connected to an input end of the at least one of the delay circuits, and a second end connected to the first input end of the first amplifier; a second delay switch configured to be turned on in response to the gate clock signal, and including a first end and a second end connected to the second input end of the first amplifier; a sampling capacitor including a first electrode connected to the first input end of the first amplifier, and a second electrode connected to the first end of the second delay switch; a third delay switch configured to be turned on in response to an inverted gate clock signal, and including a first end connected to the input end of the at least one of the delay circuits, and a second end connected to the second electrode of the sampling capacitor; and a fourth delay switch configured to be turned on in response to the inverted gate clock signal, and including a first end connected to the output end of the first amplifier, and a second end connected to an output end of the at least one of the delay circuits. A frequency of the gate clock signal may be a product of the driving frequency and a number of the pixel rows, where j may be a positive integer greater than or equal to 2.

According to one or more embodiments of the present disclosure, a wearable electronic device includes: a processor; a first display device configured to provide an image to a user's right eye; and a second display device configured to provide an image to the user's left eye, wherein at least one of the first display device or the second display device includes: a ramp generator configured to generate a reference ramp signal, and including a resistor string includes: a first end configured to receive a high ramp voltage; and a second end configured to receive a low ramp voltage; and a ramp delayer configured to sequentially output the reference ramp signal, wherein the ramp generator is configured to: divide the high ramp voltage into first through k-th voltages by utilizing the resistor string; and sequentially output the first through k-th voltages to generate the reference ramp signal, where k is a positive integer, and wherein the wearable electronic device includes at least one of a head mounted display (HMD) device, a virtual reality (VR) device, a mixed reality (MR) device, or an augmented reality (AR) device.

In an embodiment, the ramp generator further includes a plurality of stages, each of the stages configured to output at least one of the first through k-th voltages, and includes: at least one resistor element of a plurality of resistor elements included in the resistor string; a ramp switch configured to be turned on in response to a ramp control signal, and including a first end connected to the at least one resistor element, and a second end connected to an output end of the ramp generator; and a flip-flop configured to output the ramp control signal.

In an embodiment, the flip-flop of a first stage of the plurality of stages is configured to receive a vertical start signal, and the flip-flop of a second stage of the plurality of stages is configured to receive the ramp control signal output from the flip-flop of the first stage.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a block diagram illustrating a display device according to some embodiments of the present disclosure.

FIG. 2 is a plan view illustrating an embodiment of a display panel of FIG. 1.

FIG. 3 is a cross-sectional diagram illustrating an embodiment of the display panel of FIG. 2.

FIG. 4 is a cross-sectional diagram illustrating another embodiment of the display panel of FIG. 2.

FIG. 5 is a circuit diagram illustrating an example of a subpixel of FIG. 1.

FIG. 6 is a diagram illustrating an example of a ramp driver of FIG. 1.

FIG. 7 is a diagram illustrating an example of a ramp generator of FIG. 6.

FIG. 8 is a timing diagram illustrating an example of driving the ramp generator of FIG. 7.

FIG. 9 is a diagram illustrating an example of a ramp delayer of FIG. 6.

FIG. 10 is a schematic circuit diagram illustrating an example of a delay circuit of a first delay block of FIG. 9.

FIG. 11 is a timing diagram illustrating an example of driving the delay circuit of FIG. 10.

FIG. 12 is a timing diagram illustrating an example of driving delay circuits of FIG. 9.

FIG. 13 is a schematic circuit diagram illustrating an example of an error compensator of FIG. 9.

FIG. 14 is a timing diagram illustrating an example of driving the error compensator of FIG. 13.

FIG. 15 is a schematic circuit diagram illustrating an example of a delay circuit to which a compensation control signal is applied among the delay circuits of FIG. 9.

FIG. 16 is a timing diagram illustrating an example of driving the delay circuit of FIG. 15.

FIG. 17 is a diagram illustrating another example of a ramp driver of FIG. 1.

FIG. 18 is a block diagram illustrating an example of a ramp generator of FIG. 17.

FIG. 19 is a timing diagram illustrating an example of driving the ramp generator of FIG. 18.

FIG. 20 is a timing diagram illustrating another example of driving the ramp generator of FIG. 18.

FIG. 21 is a block diagram illustrating an embodiment of a display system.

FIG. 22-FIG. 25 are perspective views illustrating application examples of the display system of FIG. 21.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

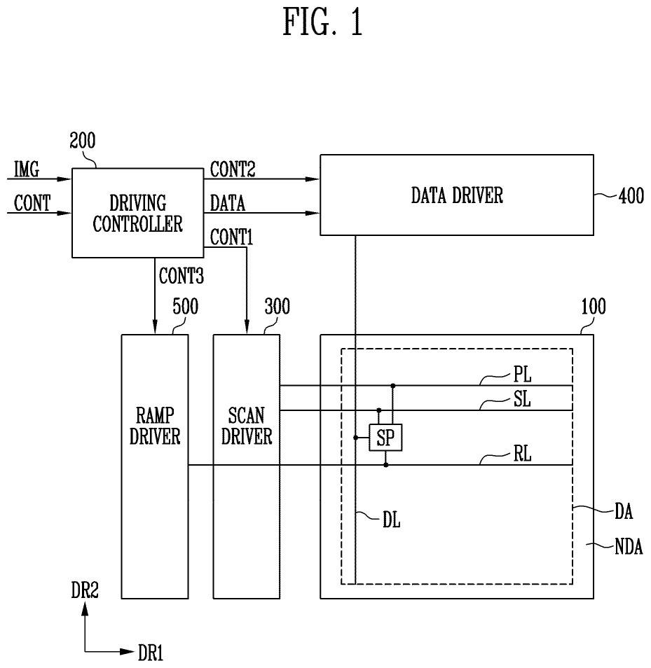

FIG. 1 is a block diagram illustrating a display device according to some embodiments of the present disclosure.

Referring to FIG. 1, the display device may include a display panel 100, a driving controller 200, a scan driver 300, a data driver 400, and a ramp driver 500. In an embodiment, the driving controller 200 and the data driver 400 may be integrated together on a single chip (e.g., on a single integrated circuit (IC)).

The display panel 100 may include a display area (DA) for displaying an image, and a non-display area (NDA) disposed adjacent to the display area (DA). In an embodiment, at least one of the scan driver 300 or the ramp driver 500 may be mounted in the non-display area (NDA).

The display panel 100 may include a plurality of scan lines (SL), a plurality of power lines (PL), a plurality of data lines (DL), a plurality of ramp lines (RL), and a plurality of subpixels (SP) electrically connected with the scan lines (SL), the power lines (PL), the data lines (DL), and the ramp lines (RL). The scan lines (SL), the power lines (PL), and the ramp lines (RL) may extend in a first direction (DR1), and the data lines (DL) may extend in a second direction (DR2) crossing or intersecting the first direction (DR1).

The driving controller 200 may receive input image data (IMG) and an input control signal (CONT) from a main processor (e.g., a graphic processing unit (GPU) or the like). For example, the input image data (IMG) may include red image data, green image data, and blue image data. In an embodiment, the input image data (IMG) may further include white image data. As another example, the input image data (IMG) may include magenta image data, yellow image data, and cyan image data. The input control signal (CONT) may include a master clock signal and a data enabling signal. The input control signal (CONT) may further include a vertical synchronization signal and a horizontal synchronization signal.

The driving controller 200 may generate a first control signal (CONT1), a second control signal (CONT2), a third control signal (CONT3), and a data signal (DATA) based on the input image data (IMG) and the input control signal (CONT).

The driving controller 200 may generate the first control signal (CONT1) for controlling the operation of the scan driver 300 based on the input control signal (CONT), and may output the first control signal (CONT1) to the scan driver 300. The first control signal (CONT1) may include a vertical initiation signal and a gate clock signal.

The driving controller 200 may generate a second control signal (CONT2) for controlling an operation of the data driver 400 based on the input control signal (CONT), and may output the second control signal (CONT2) to the data driver 400. The second control signal (CONT2) may include a horizontal initiation signal and a load signal.

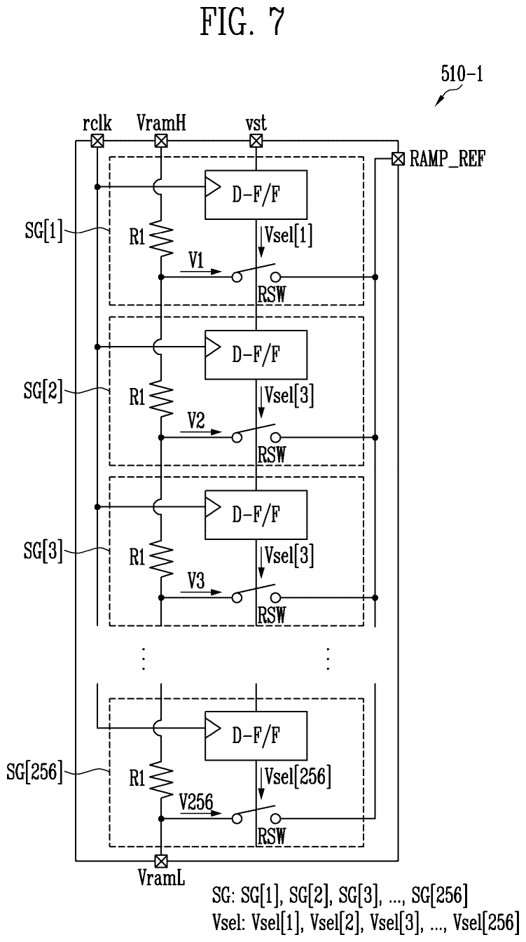

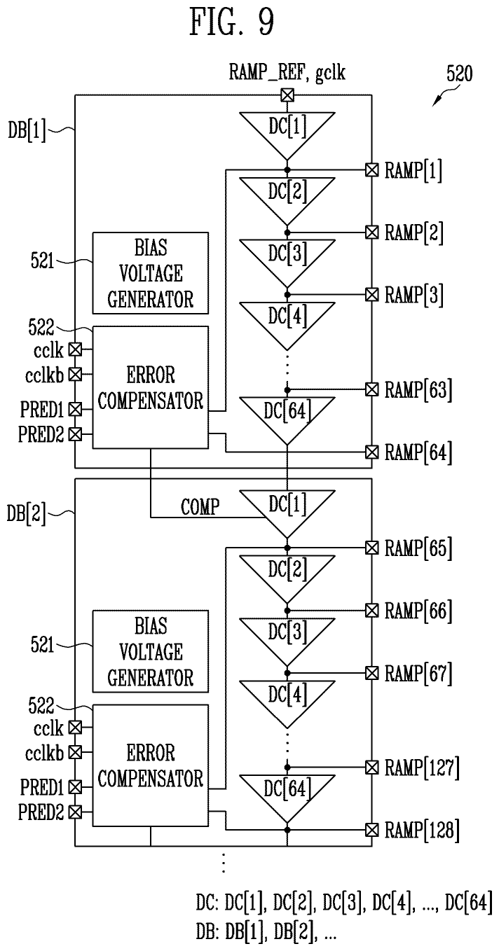

The driving controller 200 may generate the third control signal (CONT3) for controlling an operation of the ramp driver 500 based on the input control signal (CONT), and may output the third control signal (CONT3) to the ramp driver 500. The third control signal (CONT3) may include a vertical start signal (e.g., vst in FIG. 7), and clock signals (e.g., rclk, gclk, gclkb, cclk, and cclkb in FIG. 9).

The driving controller 200 may generate the data signal (DATA) by receiving the input image data (IMG) and the input control signal (CONT). The driving controller 200 may output the data signal (DATA) to the data driver 400.

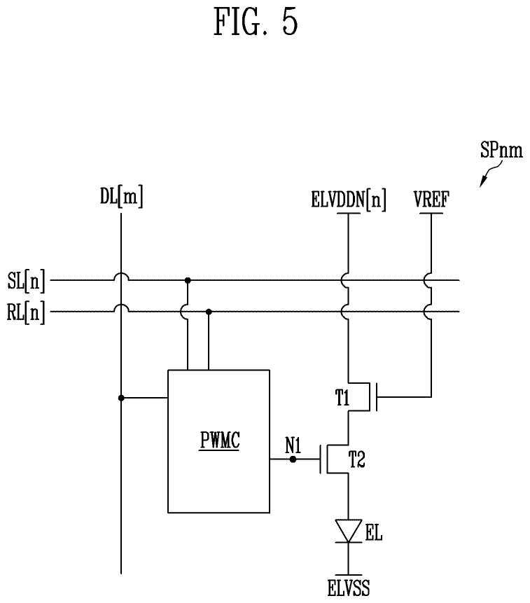

The scan driver 300 may generate scan signals for driving the scan lines (SL) (e.g., SL[n] in FIG. 5), and power signals (e.g., a first power voltage ELVDD[n] in FIG. 5) for driving the power lines (PL) in response to the first control signal (CONT1) input from the driving controller 200. The scan driver 300 may output the scan signals to the scan lines (SL). The scan driver 300 may output the power signals to the power lines (PL). For example, the scan driver 300 may sequentially output the scan signals to the scan lines (SL), and may sequentially output the power signals to the power lines (PL).

In the present embodiment the scan driver 300 is illustrated as providing the scan signals and the power signals, but the present disclosure is not limited thereto. For example, the scan driver 300 may provide the scan signals, and a separate configuration or component from the scan driver 300 (e.g., a power supply or a power generator) may provide the power signals.

In the present embodiment, the power signals are illustrated as being provided to pixel rows through the power lines (PL), respectively, but the present disclosure is not limited thereto. For example, the same power signal may be applied to all of the subpixels (SP), and the power signal may be provided from a separate configuration or component.

The data driver 400 may receive the second control signal (CONT2) and the data signal (DATA) from the driving controller 200. The data driver 400 may generate data voltages obtained by converting the data signal (DATA) into an analog voltage. The data driver 400 may output the data voltages to the data lines (DL).

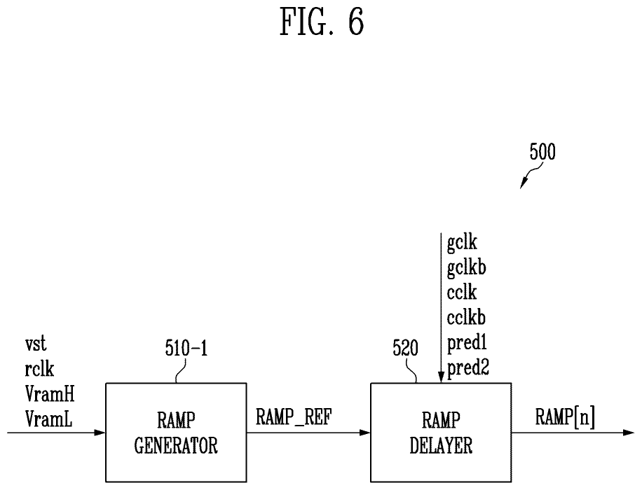

The ramp driver 500 may generate ramp signals (e.g., RAMP [n] in FIG. 6) 1 for driving the ramp lines (RL) in response to the third control signal (CONT3) input from the driving controller 200. The ramp driver 500 may output the ramp signals to the ramp lines (RL). For example, the ramp driver 500 may sequentially output the ramp signals to the ramp lines (RL).

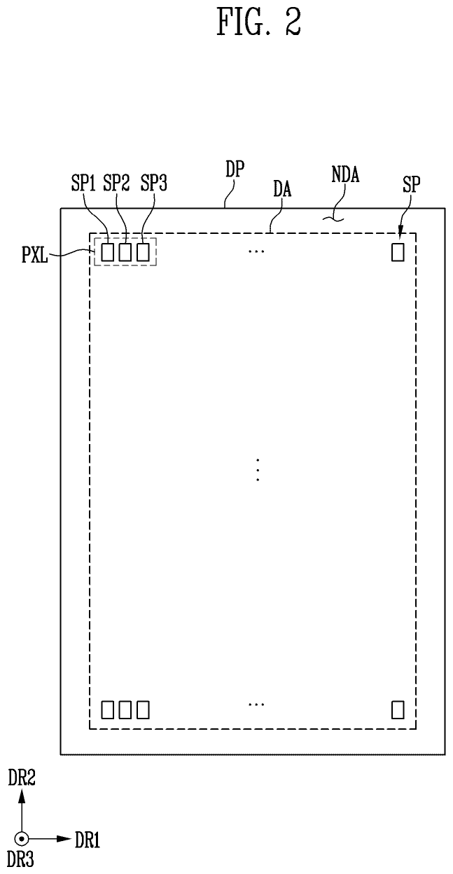

FIG. 2 is a plan view illustrating an embodiment of the display panel of FIG. 1. In other words, in some embodiments, the display panel (DP) in FIG. 2 may correspond to the display panel 100 described above with reference to FIG. 1.

Referring to FIG. 2, the display panel (DP) may include a display area (DA) and a non-display area (NDA). The display panel (DP) displays an image through the display area (DA). The non-display area (NDA) is disposed around the display area (DA).

The display panel (DP) includes subpixels (SP) in the display area (DA). The subpixels (SP) may be arranged along the first direction (DR1) and the second direction (DR2) crossing or intersecting the first direction (DR1). For example, the subpixels (SP) may be arranged in a matrix form along the first direction (DR1) and the second direction (DR2). As another example, the subpixels (SP) may be arranged in a zigzag form along the first direction (DR1) and the second direction (DR2). The arrangement of the subpixels (SP) may be variously modified as needed or desired. The first direction (DR1) may be a row direction, and the second direction (DR2) may be a column direction.

Two or more subpixels of the plurality of subpixels (SP) may configure one pixel (PXL). FIG. 2 shows that a pixel (PXL) includes three subpixels (SP1 through SP3), but the present disclosure is not limited thereto. For example, the pixel (PXL) may include two subpixels. Hereinafter, for convenience of illustration, the pixel (PXL) may be described in more detail as including the first through third subpixels (SP1 through SP3), but the present disclosure is not limited thereto.

The first through third subpixels (SP1 through SP3) may each generate light of one from among various suitable colors, such as red, green, blue, cyan, magenta, and/or yellow. Hereafter, for convenience of illustration, the first subpixel (SP1) may be described in more detail as producing light of the red color, the second subpixel (SP2) may be described in more detail as producing light of the green color, and the third subpixel (SP3) may be described in more detail as producing light of the blue color, but the present disclosure is not limited thereto.

The first through third subpixels (SP1 through SP3) may each include at least one light emitting element to generate light. In some embodiments, the light emitting elements of the first through third subpixels (SP1 through SP3) may produce light of the same color as each other. For example, the light emitting elements of the first through third subpixels (SP1 through SP3) may generate blue-colored light. In other embodiments, light emitting elements of the first through third subpixels (SP1 through SP3) may produce light of different colors from each other. For example, the light emitting elements of the first through third subpixels (SP1 through SP3) may produce red, green, and blue light, respectively.

The display panel (DP) may include (e.g., may be or may use) a self-luminescent display panel, such as an LED display panel that uses a microscale light emitting diode or a nanoscale light emitting diode as the light emitting element, or an organic light emitting display panel (e.g., an OLED panel) which uses an organic light emitting diode as the light emitting element.

In the non-display area (NDA), a component for controlling the subpixels (SP) may be disposed. Wirings connected to the subpixels (SP), for example, such as first through m-th gate lines (GL1 through GLm), first through n-th data lines (DL1 through DLn), the power lines (PL), and pixel control lines (PXCL), where m and n are natural numbers, may be disposed in the non-display area (NDA).

At least one of the driving controller 200, the scan driver 300, the data driver 400, or the ramp driver 500 described above with reference to FIG. 1 may be disposed in the non-display area (NDA) of the display panel (DP). In some embodiments, the scan driver 300 and the ramp driver 500 may be disposed in the non-display area (NDA). In this case, the driving controller 200 and the data driver 400 may be implemented as a driver integrated circuit separated from the display panel (DP), and the driver integrated circuit may be connected to some of the wirings disposed in the non-display area (NDA). In other embodiments, the scan driver 300 and the ramp driver 500 may be implemented as one integrated circuit separated from the display panel (DP), together with the driving controller 200 and the data driver 400.

In some embodiments, the display area (DA) may have various suitable shapes. The display area (DA) may have a closed-loop shape including straight and/or curved sides. For example, the display area (DA) may have various suitable shapes, such as a polygon, a circle, a semicircle, or an ellipse.

In some embodiments, the display panel (DP) may have a flat or substantially flat display surface. In other embodiments, the display panel (DP) may have a display surface which is at least in part rounded. In some embodiments, the display panel (DP) may be bendable, foldable, or rollable. In such cases, the display panel (DP) and/or a substrate of the display panel (DP) may include one or more suitable materials having flexible properties.

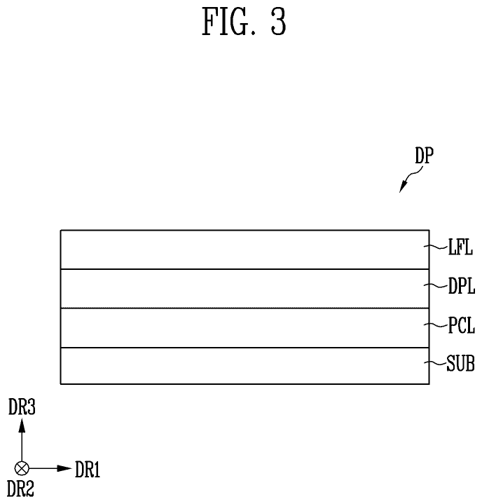

FIG. 3 is a cross-sectional diagram illustrating an embodiment of the display panel of FIG. 2.

Referring to FIG. 3, the display panel (DP) may include a substrate (SUB), and a pixel circuit layer (PCL), a display element layer (DPL), and a light functional layer (LFL), which are sequentially stacked on the substrate (SUB) in a third direction (DR3) crossing or intersecting the first and second directions (DR1, DR2).

The substrate (SUB) may include (e.g., may be formed of) an insulating material, such as glass or a resin. For example, the substrate (SUB) may include a glass substrate. As another example, the substrate (SUB) may include a polyimide substrate (PI). As another example, the substrate (SUB) may include a silicon wafer substrate formed using a semiconductor process.

In some embodiments, the substrate (SUB) may include (e.g., may be formed of) a flexible material to allow for bending or folding, and may have a single-layer structure or a multi-layered structure. For example, the flexible material may include at least one of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, or cellulose acetate propionate. However, the present disclosure is not necessarily limited thereto.

The pixel circuit layer (PCL) is disposed on the substrate (SUB). The pixel circuit layer (PCL) may include insulation layers, semiconductor patterns, and conductive patterns disposed between the insulation layers. The conductive patterns of the pixel circuit layer (PCL) may function as circuit elements, wirings, and the like.

The circuit elements of the pixel circuit layer (PCL) may include a subpixel circuit of each of the subpixels (SP) described above with reference to FIG. 2. In other words, the circuit elements of the pixel circuit layer (PCL) may be provided as transistors and one or more capacitors of the subpixel circuit (SPC).

The wiring of the pixel circuit layer (PCL) may include a wiring connected to the subpixels (SP). The wiring of the pixel circuit layer (PCL) may include various suitable signal lines and/or voltage lines used to drive the display element layer (DPL).

The display element layer (DPL) is disposed on the pixel circuit layer (PCL). The display element layer (DPL) may include light emitting elements of the subpixels (SP).

The light functional layer (LFL) may be disposed on the display element layer (DPL). The light functional layer (LFL) may include light conversion patterns having color conversion particles and/or scattering particles. For example, the color conversion particles may include quantum dots. The quantum dots may change a wavelength (e.g., the color) of the light emitted from the display element layer (DPL). The light functional layer (LFL) may further include light scattering patterns having scattering particles. In some embodiments, the light conversion patterns and the light scattering patterns may be omitted as needed or desired.

The light functional layer (LFL) may further include a color filter layer including color filters. The color filter may selectively transmit light of a suitable color (e.g., a specific or predetermined wavelength or color). In some embodiments, the color filter layer may be omitted as needed or desired.

A window for protecting an exposed surface (e.g., the top surface) of the display panel (DP) may be provided on the light functional layer (LFL). The window may protect the display panel (DP) from an external impact. The window may be connected to (e.g., coupled to or attached to) the light functional layer (LFL) using an optically transparent adhesive (e.g., a gluing) member. The window may have a multi-layered structure selected from a glass substrate, a plastic film, and/or a plastic substrate. The multi-layered structure may be formed through a continuous process, or an adhesion process using an adhesive layer. All or a part of the window may be flexible.

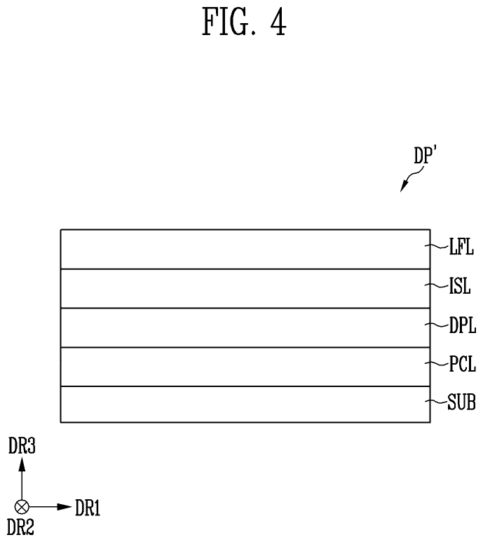

FIG. 4 is a cross-sectional diagram illustrating another embodiment of the display panel of FIG. 2.

Referring to FIG. 4, the display panel (DP) may include a substrate (SUB), a pixel circuit layer (PCL), a display element layer (DPL), an input sensing layer (ISL), and a light functional layer (LFL). The substrate (SUB), the pixel circuit layer (PCL), the display element layer (DPL), and the light functional layer (LFL) may be the same or substantially the same as the substrate (SUB), the pixel circuit layer (PCL), the display element layer (DPL), and the light functional layer (LFL) described above with reference to FIG. 4, and thus, redundant description may not be repeated.

The input sensing layer (ISL) may detect a user input to the top surface (e.g., the display surface) of the display panel (DP). The input sensing layer (ISL) may include various suitable configurations appropriate for detecting an external object such as a user's hand or a pen. For example, the input sensing layer (ISL) may include touch electrodes.

FIG. 5 is a circuit diagram illustrating an example of the subpixel of FIG. 1.

In FIG. 5, a subpixel (SPnm) arranged in an n-th row (where n is a positive integer) and an m-th column (where m is a positive integer) from among the subpixels (SP) described above with reference to FIG. 1 is illustrated as a representative example.

Referring to FIG. 5, the subpixel (SPnm) may include a PWM generation circuit (PWMC), a first transistor (T1), a second transistor (T2), and a light emitting element (EL).

An anode electrode of the light emitting element (EL) may be connected to a first power voltage (ELVDD[n]) via the first transistor (T1) and the second transistor (T2), and a cathode electrode of the light emitting element (LD) may be connected to a second power voltage (ELVSS).

The PWM generation circuit (PWMC) may be connected to an n-th scan line (SL[n]) of the scan lines (SL) described above with reference to FIG. 1, an n-th ramp line (RL[n]) of the ramp lines (RL), and an m-th data line (DL[m]) of the data lines (DL). The PWM generation circuit (PWMC) may be connected to a control electrode of the second transistor (T2). However, the PWM generation circuit (PWMC) according to some embodiments of the present disclosure may be operated in a PWM manner by using the ramp signal provided to the n-th ramp line (RL[n]). Referring to FIG. 5, the subpixel (SPnm) may include the light emitting element (EL) that receives a driving current to emit light, the first transistor (T1) that generates the driving current, and the second transistor (T2) that transmits the driving current to the light emitting element (EL) in response to a signal of a first node (N1).

For example, the first transistor (T1) may include a control electrode for receiving a reference voltage (VREF), a first electrode for receiving the first power voltage (ELVDD[n]), and a second electrode connected to the second transistor (T2). The second transistor (T2) may include a control electrode connected to the first node (N1), a first electrode connected to the first transistor (T1), and a second electrode connected to the light emitting element (EL). The light emitting element (EL) may include a first electrode connected to the second transistor (T2), and a second electrode for receiving the second power voltage (ELVSS).

The transistors of the PWM generation circuit (PWMC), the first transistor (T1), and the second transistor (T2) may be implemented as p-channel metal oxide semiconductor (PMOS) transistors. For example, the transistors (e.g., T1, T2) may be P-type oxide thin film transistors.

However, the present disclosure is not limited thereto. For example, at least one of the transistors of the PWM generation circuit (PWMC), the first transistor (T1), or the second transistor (T2) may be implemented as an n-channel metal oxide semiconductor (NMOS) transistor. For example, at least one of the transistors of the PWM generation circuit (PWMC), the first transistor (T1), or the second transistor (T2) may be an N-type silicon thin film transistor.

The oxide thin film transistor may be a low temperature polycrystalline oxide (LTPO) thin film transistor of which an active pattern (e.g., a semiconductor layer) includes an oxide. However, the present disclosure is not limited thereto, and the N-type transistors are not limited thereto. For example, the active pattern (e.g., the semiconductor layer) included in the N-type transistor may include an inorganic semiconductor (e.g., amorphous silicon, polysilicon, or the like) or an organic semiconductor. The silicon thin film transistor may be a low temperature poly-silicon (LTPS) thin film transistor of which an active pattern (e.g., a semiconductor layer) includes amorphous silicon, polysilicon, and/or the like.

In the NMOS transistor, a low voltage level may be an inactivation level, and a high voltage level may be an activation level. In the PMOS transistor, a low voltage level may be the activation level, and a high voltage level may be the inactivation level.

In a writing period, a data voltage may be applied to the PWM generation circuit (PWMC), and the data voltage may be written. A magnitude of the data voltage may vary depending on a grayscale (e.g., a grayscale level or value).

In an emission period, the first transistor (T1) may generate the driving current of a constant or substantially constant magnitude, the second transistor (T2) may be turned on, and the light emitting element (EL) may emit light. As the ramp signal (RAMP[n]) decreases, the first power voltage (ELVDD[n]) is output from the PWM generation circuit (PWMC) to the first node (N1), and the same voltage is applied to the control electrode and the first electrode of the second transistor (T2), and accordingly the second transistor (T2) may be turned off and the light emitting element (EL) may not emit light.

In other words, a time of the driving current flowing to the light emitting element (EL) may vary depending on the grayscale. Depending on the grayscale, the magnitude of the data voltage may vary. For example, as the grayscale increases, the magnitude of the data voltage may increase. As the driving current flows through the light emitting element (EL) longer, the light emitting element (EL) may display a higher grayscale. The magnitudes of the first power voltage (ELVDD[n]), the scan signal of the n-th scan line (SL[n]), and the ramp signal of the n-th ramp line (RL[n]) may be irrelevant to the grayscale.

FIG. 6 is a diagram illustrating an example of the ramp driver of FIG. 1.

Referring to FIG. 1 and FIG. 6, a ramp driver 500 may include a ramp generator 510-1 for generating a reference ramp signal (RAMP_REF), and a ramp delayer 520 for sequentially outputting the reference ramp signal (RAMP_REF).

The ramp generator 510-1 may receive a vertical start signal (vst), the ramp clock signal (rclk), a high ramp voltage (VramH), and a low ramp voltage (VramL), and may generate the reference ramp signal (RAMP_REF).

The vertical start signal (vst) and the ramp clock signal (rclk) may be included in the third control signal (CONT3). For example, the vertical start signal (vst) may be a vertical synchronization signal.

In an embodiment, the high ramp voltage (VramH) and the low ramp voltage (VramL) may be provided to the ramp generator 510-1 from outside of the display device. For example, the high ramp voltage (VramH) and the low ramp voltage (VramL) may be provided from a power management integrated circuit (PMIC) to the ramp generator 510-1.

In another embodiment, the high ramp voltage (VramH) and the low ramp voltage (VramL) may be provided from the driving controller 200 or a power voltage generator inside the display device. For example, the driving controller 200 or the power voltage generator may receive a reference power voltage from the outside, and may generate the high ramp voltage (VramH) and the low ramp voltage (VramL).

The ramp delayer 520 may receive the reference ramp signal (RAMP_REF), a gate clock signal (gclk), an inverted gate clock signal (gclkb), a compensation clock signal (cclk), an inverted compensation clock signal (cclkb), a first predicted voltage (pred1), and a second predicted voltage (pred2), and may generate a ramp signal (RAMP[n]).

The gate clock signal (gclk), the inverted gate clock signal (gclkb), the compensation clock signal (cclk), and the inverted compensation clock signal (cclkb) may be included in the third control signal (CONT3). For example, the inverted gate clock signal (gclkb) may be an inverted signal of the gate clock signal (gclk), and the inverted compensated clock signal (cclkb) may be an inverted signal of the compensation clock signal (cclk).

In an embodiment, the first predicted voltage (pred1) and the second predicted voltage (pred2) may be provided to the ramp generator 510-1 from the outside of the display device. For example, the first predicted voltage (pred1) and the second predicted voltage (pred2) may be provided from the power management integrated circuit to the ramp delayer 520.

In another embodiment, the first predicted voltage (pred1) and the second predicted voltage (pred2) may be provided from the driving controller 200 or the power voltage generator inside the display device. For example, the driving controller 200 or the power voltage generator may receive a reference power voltage from the outside, and may generate the first predicted voltage (pred1) and the second predicted voltage (pred2).

FIG. 7 is a diagram illustrating an example of the ramp generator of FIG. 6.

Referring to FIG. 7, the ramp generator 510-1 may include a resistor string (e.g., a resistor string including first resistor elements (R1)) disposed between a first end applied with the high ramp voltage (VramH) and a second end applied with the low ramp voltage (VramL). The ramp generator 510-1 may generate (e.g., may divide into) first through k-th voltages from the low ramp voltage (VramL) to the high ramp voltage (VramH) by using (e.g., by means of) the resistor string, and may sequentially output the first through k-th voltages, and thus, may generate the reference ramp signal (RAMP_REF). For example, the ramp generator 510-1 includes stages (SG), and the stages (SG) may each output at least one of the first through k-th voltages. Here, k is a positive integer, and k is illustratively shown to be 256 in FIG. 7.

The stages (SG) may each include at least one of the first resistor elements (R1) included in the resistor string. For example, the first through 256th stages (SG[1] through SG[256]) may each include one first resistor element (R1).

Each of the stages (SG) may include a ramp switch (RSW) that is sequentially turned on in response to the ramp clock signal (rclk) and the vertical start signal (vst). The ramp switch (RSW) includes a first end connected to the first resistor element (R1), and a second end connected to the output end of the ramp generator 510-1. Each of the stages (SG) may further include a flip-flop (D-F/F) for outputting a ramp control signal (Vsel).

For example, the flip-flop (D-F/F) of the first stage (SG[1]) may receive the 1 vertical start signal (vst), and the flip-flop (D-F/F) of the second stage(SG [2]) may receive a first ramp control signal (Vsel[1]) output from the flip-flop (D-F/F) of the first stage (SG[1]). The third through 256th stages (SG[3] through SG[256]) may receive a ramp control signal (Vsel) of a previous stage in the same or substantially the same manner as that of the second stage (SG[2]) described above.

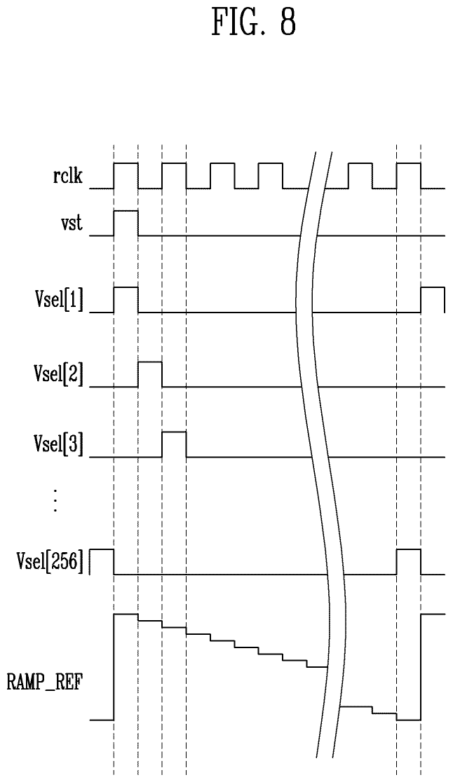

FIG. 8 is a timing diagram illustrating an example of driving the ramp generator of FIG. 7.

Referring to FIG. 1, FIG. 7, and FIG. 8, the driving controller 200 may drive the display panel 100 at a suitable driving frequency. The ramp generator 510-1 may include the stages (SG) for sequentially outputting the first through k-th voltages (e.g., the first through 256th voltages (V1 through V256)) at each cycle of the ramp clock signal (rckl). The frequency of the ramp clock signal (rclk) may be a product of the driving frequency and the number of first resistor elements (R1) of the resistor string.

The vertical start signal (vst) may have an activation level if (e.g., when) one frame starts. The flip-flop (D-F/F) of the first stage (SG[1]) may output a first ramp control signal (Vsel[1]) in response to the vertical start signal (vst) and the ramp clock signal (rclk). In response to the first ramp control signal (Vsel[1]), the ramp switch (RSW) of the first stage (SG[1]) may be turned on, and the first voltage (V1) may be output to the output end of the ramp generator 510-1.

The flip-flop (D-F/F) of the second stage (SG[2]) may output a second ramp control signal (Vsel[2]) in response to the first ramp control signal (Vsel[1]) and the ramp clock signal (rclk). In response to the second ramp control signal (Vsel[2]), the ramp switch (RSW) of the second stage (SG[2]) may be turned on, and the second voltage (V2) may be output to the output end of the ramp generator 510-1.

Hereafter, because the third through 256th stages (SG[3] through SG[256]) operate in the same or substantially the same way as that of the second stage (SG[2]) described above, redundant description thereof may not be repeated.

By using (e.g., by means of) the resistor string, the first through 256th voltages (V1 through V256) increase when approaching the high ramp voltage (VramH), and decrease when approaching the low ramp voltage (VramL), and the reference ramp signal (RAMP_REF) may be a sum of the first through 256th voltages (V1 through V256). Accordingly, the reference ramp signal (RAMP_REF) may gradually decrease.

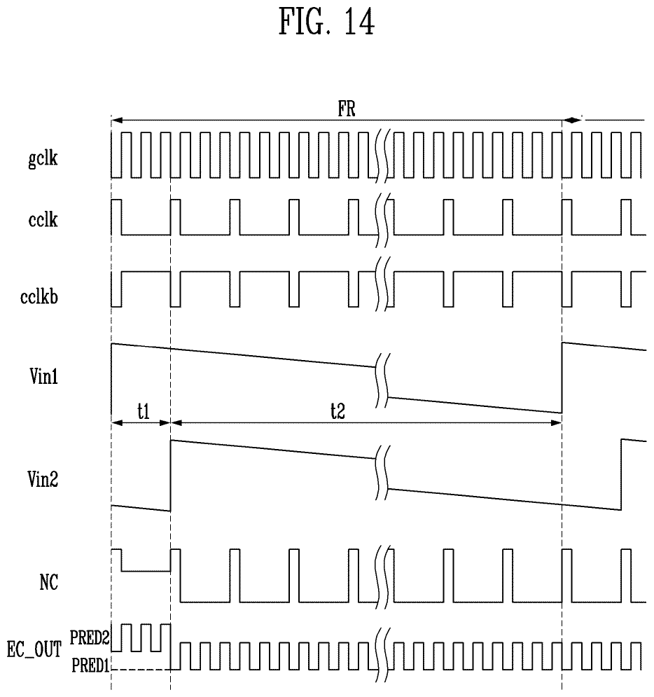

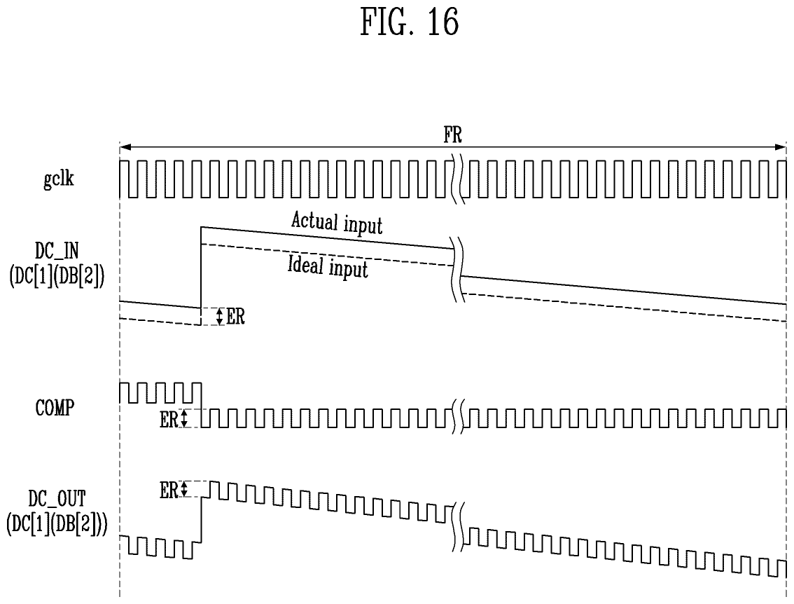

However, for convenience of illustration, FIG. 14 and FIG. 16 show the reference ramp signal (RAMP_REF) briefly instead of in steps.

FIG. 9 is a diagram illustrating an example of the ramp delayer of FIG. 6.

Referring to FIG. 9, the ramp delayer 520 (e.g., each ramp delayer 520) may include j (here, j is a positive integer greater than or equal to 2) delay blocks (DB). Each of the delay blocks (DB) may include k (here, k is a positive integer greater than or equal to 2) delay circuits (DC) for delaying an input signal. A first delay circuit (DC[1]) of a first delay block (DB[1]) may receive the reference ramp signal (RAMP_REF) and the gate clock signal (gclk), and a first delay circuit (DC[1]) of a second delay block (DB[2]) may receive an output signal of a k-th delay circuit (e.g., a 64th delay circuit (DC[64])) of the first delay block (DB[1]). Here, k is illustratively shown to be 64 in FIG. 9.

An output signal of each of the delay circuits (DC) may be provided as the ramp signal (e.g., RAMP[n] in FIG. 6) to one pixel row. For example, the first through 64th delay circuit (DC[1] through DC[64]) of the first delay block (DB[1]) may sequentially output first through 64th ramp signals (RAMP[1] through RAMP[64]), and the first through 64th delay circuits (DC[1] through DC[64]) of the second delay block (DB[2]) may sequentially output 65th through 128th ramp signals (RAMP[65] through RAMP[128]).

Because the delay blocks after the second delay block (DB[2]) operate in the same or substantially the same way as that of the second delay block (DB[2]), redundant description thereof may not be repeated.

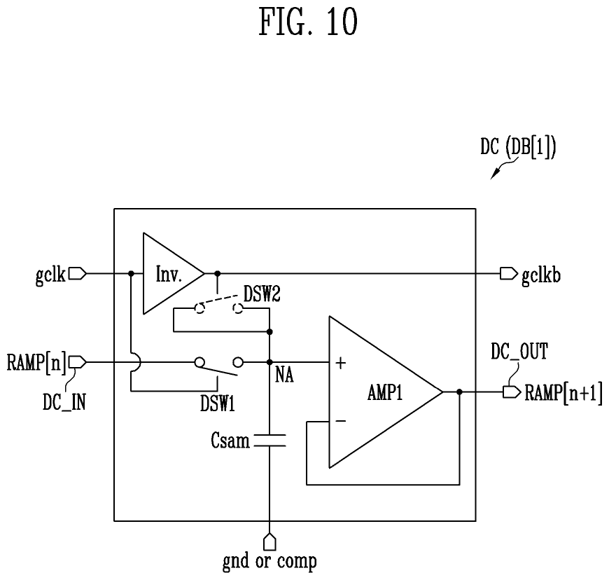

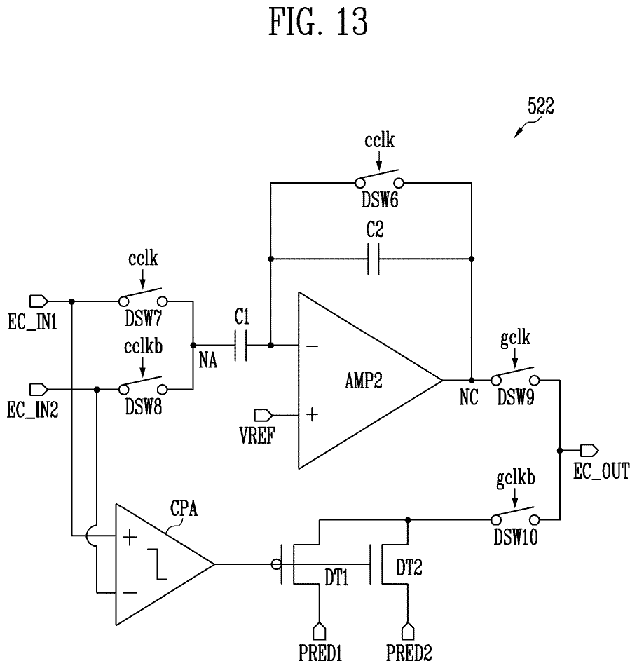

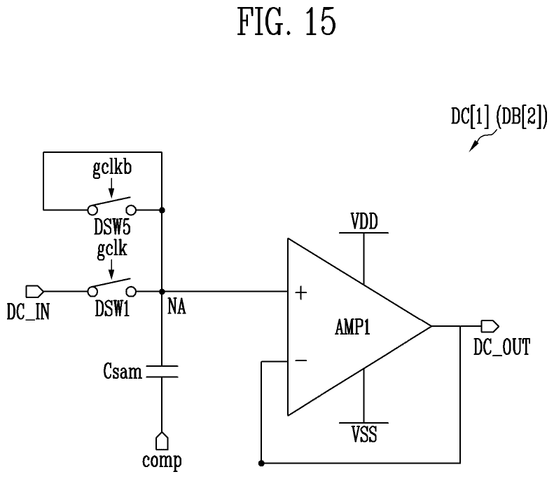

The delay blocks (DB) may each include a bias voltage generator 521. The bias voltage generator 521 may apply a bias voltage to a first amplifier (e.g., AMP1 in FIG. 10 and FIG. 15) and a second amplifier (AMP2 in FIG. 13) to be described in more detail below. The first amplifier and the second amplifier may be driven by receiving the bias voltage.

Each of the delay blocks (DB) may include an error compensator 522. The error compensator 522 will be described in more detail below.

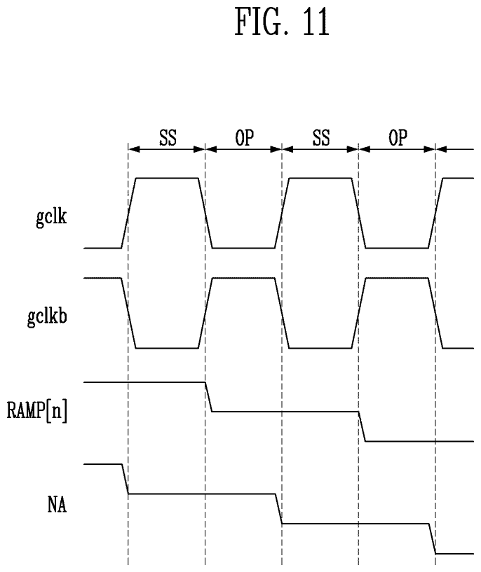

FIG. 10 is a schematic circuit diagram illustrating an example of a delay circuit of the first delay block of FIG. 9. FIG. 11 is a timing diagram illustrating an example of driving the delay circuit of FIG. 10.

The delay circuits (DC), except for the delay circuit (e.g., the first delay circuit (DC[1]) of the second delay block(DB [2])) that receives the compensation control signal (COMP), are the same or substantially the same as the delay circuit (DC) illustrated in FIG. 10, and thus, redundant description thereof may not be repeated hereinafter.

Referring to FIG. 9 and FIG. 10, the delay circuit (DC) may include a first amplifier (AMP1), a first delay switch (DSW1), a second delay switch (DSW2), and a sampling capacitor (Csam). The first amplifier (AMP1) may include a first input end, a second input end, and an output end connected to the second input end. The first delay switch (DSW1) may be turned on in response to the gate clock signal (gclk), and may include a first end connected to an input end (DC_IN) of the delay circuit (DC), and a second end connected to the first input end of the first amplifier (AMP1). The second delay switch (DSW2) may be turned on in response to the inverted gate clock signal (gclkb), and may include a first end and second end connected to the first input end of the first amplifier (AMP1). The sampling capacitor (Csam) may include a first electrode connected to the first input end of the first amplifier (AMP1), and a second electrode connected to ground (gnd) (or, the compensation control signal (COMP)). The frequency of the gate clock signal (gclk) may be the product of the driving frequency of each frame (FR) and the number of pixel rows.

The first amplifier (AMP1) may be driven by receiving the first driving voltage (VDD) and the second driving voltage (VSS). The first amplifier (AMP1) may be driven by receiving the bias voltage, in addition to the first driving voltage (VDD) and the second driving voltage (VSS).

Referring to FIG. 10 and FIG. 11, the gate clock signal (gclk) may have the activation level in a sampling period (SS), and the inactivation voltage level in an output period (OP). The inverted gate clock signal (gclkb) may have the inactivation level in the sampling period (SS), and the activation level in the output period (OP). The first amplifier (AMP1) may be a single-gain amplifier.

In the sampling period (SS), the first delay switch (DSW1) may be turned on, and the second delay switch (DSW2) may be turned off. A voltage (VIN) of the input end (DC_IN) of the delay circuit (DC) may be applied to a node (NA) connected to the first input end of the first amplifier (AMP1), and a voltage of an output end (DC_OUT) of the delay circuit (DC) may be applied to the second input end of the first amplifier (AMP1). The voltage (VIN) of the input end (DC_IN) of the delay circuit (DC) may be the n-th ramp signal (RAMP[n]), and the voltage of the output end (DC_OUT) of the delay circuit (DC) may be an n+1-th ramp signal (RAMP[n+1]). The sampling capacitor (Csam) may be charged by the n-th ramp signal (RAMP[n]) applied to the node (NA). Thus, in the sampling period (SS), the voltage of the node (NA) may be equal to or substantially equal to the voltage of the n-th ramp signal (RAMP[n]).

In the output period (OP), the first delay switch (DSW1) may be turned off, and the second delay switch (DSW2) may be turned on. The voltage of the node (NA) may be maintained by the sampling capacitor (Csam). Thus, in the output period (OP), the voltage of the node (NA) may maintain the voltage of the n-th ramp signal (RAMP[n]) in the sampling period (SS).

Accordingly, the voltage (VIN) of the input end (DC_IN) of the delay circuit (DC) may be output through the delay circuit (DC). The n-th ramp signal (RAMP[n]) of the input end (DC_IN) of the delay circuit (DC) may have a signal of the same kind as that of the reference ramp signal (RAMP_REF).

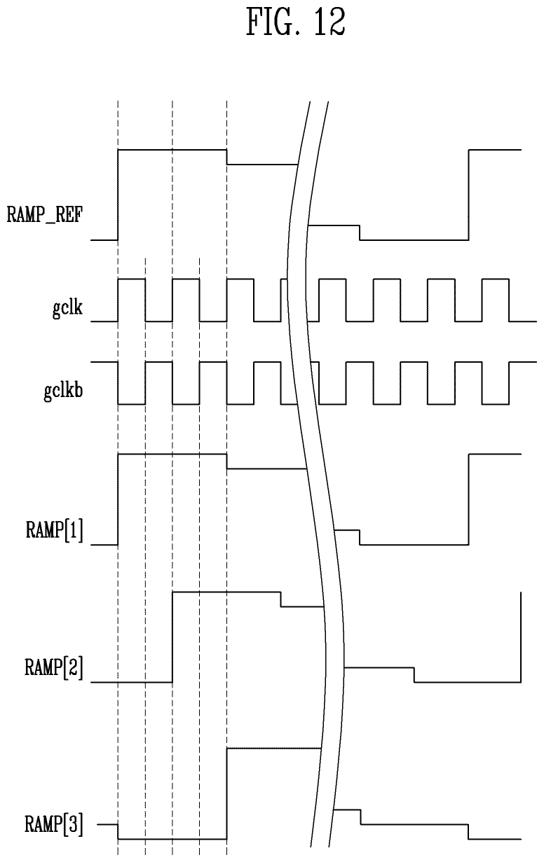

FIG. 12 is a timing diagram illustrating an example of driving the delay circuits of FIG. 9.

For convenience of illustration, FIG. 12 ignores an effect of an offset voltage (e.g., Vos in FIG. 11), and represents the first through third ramp signals (RAMP[1] to RAMP[3]) the same as that of the reference ramp signal (RAMP_REF).

Referring to FIG. 9 and FIG. 12, the delay circuits (DC) may sequentially output the reference ramp signal (RAMP_REF) as the ramp signal (e.g., RAMP[n] in FIG. 6) in response to the gate clock signal (gclk).

For example, the first delay circuit (DC[1]) of the first delay block (DB[1]) may output the reference ramp signal (RAMP_REF) as the first ramp signal (RAMP[1]), the second delay circuit (DC[2]) of the first delay block (DB[1]) may output the reference ramp signal (RAMP_REF) as the second ramp signal (RAMP[2]), and the third delay circuit (DC[3]) of the first delay block (DB[1]) may output the reference ramp signal (RAMP_REF) as the third ramp signal (RAMP[3]).

FIG. 13 is a schematic circuit diagram illustrating an example of the error compensator of FIG. 9.

Referring to FIG. 9 and FIG. 13, the error compensator 522 may generate the compensation control signal (COMP) by comparing the output signal of the first delay circuit (DC[1]) and the output signal of the 64th delay circuit (DC[64]) (e.g., the last delay circuit).

The error compensator 522 may include a second amplifier (AMP2), a first capacitor (C1), a second capacitor (C2), a sixth delay switch (DSW6), a seventh delay switch (DSW7), an eighth delay switch (DSW8), a ninth delay switch (DSW9), a comparator (CPA), a first delay transistor (DT1), a second delay transistor (DT2), and a tenth delay switch (DSW10). The second amplifier (AMP2) may include a first input end, a second input end for receiving the reference voltage (VREF), and an output end. The first capacitor (C1) may include a first electrode and a second electrode connected to the first input end of the second amplifier (AMP2). The second capacitor (C2) may include a first electrode connected to the first input end of the second amplifier (AMP2), and a second electrode connected to the output end of the second amplifier (AMP2). The sixth delay switch (DSW6) may be turned on in response to the compensating clock signal (cclk), and may include a first end connected to the first input end of the second amplifier (AMP2), and a second end connected to the output end of the second amplifier (AMP2). The seventh delay switch (DSW7) may be turned on in response to the inverted compensation clock signal (cclkb), and may include a first end connected to a first input end (EC_IN1) of the error compensator 522, and a second end connected to the first electrode of the first capacitor (C1). The eighth delay switch (DSW8) may be turned on in response to the compensation clock signal (cclk), and may include a first end connected to a second input end (EC_IN2) of the error compensator 522, and a second end connected to the first electrode of the first capacitor (C1). The ninth delay switch (DSW9) may be turned on in response to the gate clock signal (gclk), and may include a first end connected to the output end of the second amplifier (AMP2), and a second end connected to an output end of the error compensator 522. The comparator (CPA) may receive a signal (e.g., the output signal of the first delay circuit (e.g., DC[1] in FIG. 10)) of the first input end of the error compensator 522 and a signal (e.g., the output signal of the 64th delay circuit (e.g., DC[64] in FIG. 10)) of the second input end of the error compensator 522, and may output a comparison signal. The first delay transistor (DT1) may include a control electrode that receives the comparison signal, a first electrode that receives a first predicted voltage (PRED1), and a second electrode. The second delay transistor (DT2) may include a control electrode that receives the comparison signal, a first electrode that receives a second predicted voltage (PRED1) different from the first predicted voltage (PRED1), and a second electrode. The tenth delay switch (DSW10) may be turned on in response to the inverted gate clock signal (gclkb), and may include a first end connected to the second electrode of the first delay transistor (DT1) and the second electrode of the second transistor (DT2), and a second end connected to the output end (EC_OUT) of the error compensator 522.

The first delay transistor (DT1) may be of a different kind of transistor from that of the second transistor (DT2). For example, the first delay transistor (DT1) may be implemented with a PMOS transistor, and the second transistor (DT2) may be implemented with an NMOS transistor.

FIG. 14 is a timing diagram illustrating an example of driving the error compensator of FIG. 13.

Referring to FIG. 9, FIG. 13, and FIG. 14, if (e.g., when) the compensation clock signal (cclk) has the deactivation level, the voltage (Vin2) of the second input end (EC_IN2) of the error compensator 522 may be applied to the first electrode of the first capacitor (C1), the second capacitor (C2) may be initialized, and a voltage of a node (NC) may become the reference voltage (VREF). If (e.g., when) the compensation clock signal (cclk) has the activation level, the voltage (Vin1) of the first input end (EC_IN1) of the error compensator 522 may be applied to the first electrode of the first capacitor (C1), and the voltage of the node (NC) may be a voltage change (e.g., a voltage obtained by subtracting the voltage (Vin2) of the second input end (EC_IN2) from the voltage (Vin1) the first input end (EC_IN1)) of the first electrode of the first capacitor (C1). In other words In other words, while the compensation clock signal (cclk) has the activation level, the voltage of the node (NC) may be the voltage obtained by subtracting the output signal of the 64th delay circuit (DC[64]) from the output signal of the first delay circuit (DC[1]).

The voltage change may be smaller in a second period (t2) where the output signal of the first delay circuit DC[1]) is smaller than the output signal of the 64th delay circuit DC[64], than in a first period (t1) where the output signal of the first delay circuit (DC[1]) is greater than the output signal of the 64th delay circuit (DC[64]).

The comparator (CPA) may generate the comparison signal by comparing the voltage (Vin1) of the first input end (EC_IN1) and the voltage (Vin2) of the second input end (EC_IN1). For example, if (e.g., when) the voltage (Vin1) of the first input end (EC_IN1) is greater than the voltage (Vin2) of the second input end (EC_IN1), the comparison signal may have a high voltage level, and if (e.g., when) the voltage (Vin1) of the first input end (EC_IN1) is smaller than the voltage (Vin2) of the second input end (EC_IN1), the comparison signal may have a low voltage level. In other words, the comparison signal may have the high voltage level in the first period (t1), and the comparison signal may have the low voltage level in the second period (t2). Thus, the second predicted voltage (PRED2) may be provided to the output end (EC_OUT) of the error compensator 522 in the first period (t1), and the first predicted voltage (PRED1) may be provided to the output end (EC_OUT) of the error compensator 522 in the second period (t2).

The first predicted voltage (PRED1) may be a voltage difference between the output signal of the first delay circuit (DC[1]) and the output signal of the 64th delay circuit (DC[64]) in the second period (t2). For example, the first predicted voltage (PRED1) may be a desired value (e.g., a preset or predetermined value). For example, the first predicted voltage (PRED1) may be a value that is experimentally determined.

The second predicted voltage (PRED2) may be a voltage difference between the output signal of the first delay circuit (DC[1]) and the output signal of the 64th delay circuit (DC[64]) in the first period (t1). For example, the second predicted voltage (PRED2) may be a desired value (e.g., a preset or predetermined value). For example, the second predicted voltage (PRED2) may be a value that is experimentally determined.

Thus, the difference of the voltage (Vin1) of the first input end (EC_IN1) and the voltage (Vin2) of the second input end (EC_IN1) and the difference of the predicted voltages (PRED1, PRED2) may be a voltage error value (e.g., ER in FIG. 16) to be compensated.

The voltage (e.g., the compensation control signal (COMP)) of the output end (EC_OUT) of the error compensator 522 may alternately have the difference of the voltage (Vin1) of the first input end (EC_IN1) of the error compensator 522 and the voltage of the second input end (EC_IN2) of the error compensator 522 and the second predicted voltage (PRED2) in the first period (t1), and may alternately have the difference of the voltage (Vin1) of the first input end (EC_IN1) of the error compensator 522 and the voltage (Vin2) of the second input end (EC_IN2) of the error compensator 522 and the first predicted voltage (PRED1) in the second period (t2).

For example, in the first period (t1), if (e.g., when) the gate clock signal (gclk) has the activation level, the voltage of the node (NC) may be applied to the output end (EC_OUT) of the error compensator 522, and if (e.g., when) the gate clock signal (gclk) has the inactivation level (e.g., if the inverted gate clock signal (gclkb) has the activation level), the second predicted voltage (PRED2) may be applied to the output end (EC_OUT) of the error compensator 522.

For example, in the second period (t2), if (e.g., when) the gate clock signal (gclk) has the activation level, the voltage of the node (NC) may be applied to the output end (EC_OUT) of the error compensator 522, and if (e.g., when) the gate clock signal (gclk) has the inactivation level (e.g., if the inverted gate clock signal (gclkb) has the activation level), the first predicted voltage (PRED1) may be applied to the output end (EC_OUT) of the error compensator 522.

FIG. 15 is a circuit illustrating an example of a delay circuit applied with a compensation control signal among the delay circuits of FIG. 9.

Referring to FIG. 9 and FIG. 15, the first delay circuit (DC[1]) of each of the delay blocks (DB), except the first delay block (DB[1]), may receive the compensation control signal (COMP). FIG. 15 illustrates only the first delay circuit (DC[1]) of the second delay block (DB[2]), but the first delay circuit (DC[1]) of each of the delay blocks (DB), except the first delay block (DB[1]), may be the same or substantially the same as the first delay circuit (DC[1]) of FIG. 15.

Among the delay circuits (DC), the first delay circuit (DC[1]) receiving the compensation control signal (COMP) may compensate for an input signal in response to the compensation control signal (COMP). For example, the first delay circuit (DC[1]) of the second delay block (DB[2]) may receive an output signal (e.g., the 64th ramp signal (RAMP[64])) of the 64th delay circuit (DC[64]) of the first delay block (DB[1]), and may compensate for the output signal of the 64th delay circuit (DC[64]) of the first delay block (DB[1]) in response to the compensation control signal (COMP) generated by the first delay block (DB[1]).

The first delay circuit (DC[1]) of the second delay block (DB[2]) may include a first amplifier (AMP1) including a first input end, a second input end, and an output end connected to the second input end. A first delay switch (DSW1) may be turned on in response to the gate clock signal (gclk), and may include a first end connected to the input end (DC_IN) of the first delay circuit (DC[1]) of the second delay block (DB[2]), and a second end connected to the first input end of the first amplifier (AMP1). A sampling capacitor (Csam) may include a first electrode connected to the first input end of the first amplifier (AMP1), and a second electrode for receiving the compensation control signal (COMP).

FIG. 16 is a timing diagram illustrating an example of driving the delay circuit of FIG. 15.

Referring to FIG. 9 and FIG. 13 through FIG. 16, as the compensation control signal (COMP) is toggled by the voltage error value (ER), the signal of the output end (DC_OUT) of the first delay circuit (DC[1]) of the second delay block (DB[2]) may be toggled by the voltage error value (ER). In addition, the second delay circuit (DC[2]) of the second delay block (DB[2]) may receive the toggled signal of the output end (DC_OUT) of the first delay circuit (DC[1]) of the second delay block (DB[2]), and may delay and output a signal corresponding to the lower voltage of the toggled signal in response to the gate clock signal (gclk). Thus, the ramp signal (e.g., RAMP[n] in FIG. 6) may be compensated for by the error compensation value (ER) in each of the delay blocks (DB). The lower voltage of the toggled signal indicates the dropped voltage, if (e.g., when) the toggled signal rises and falls repeatedly.

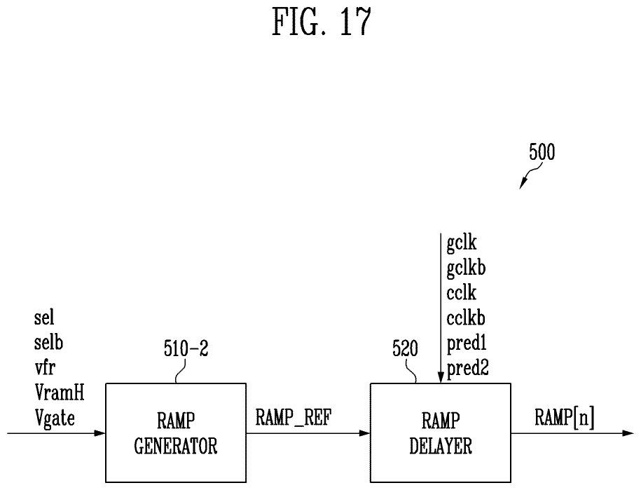

FIG. 17 is a diagram illustrating another example of the ramp driver of FIG. 1.

The ramp driver 500 illustrated in FIG. 17 may be the same or substantially the same as the ramp driver 500 described above with reference to FIG. 6, except for a ramp generator 510-2 may be different. Thus, the same reference numbers and reference symbols are used to denote the same or similar components, and thus, redundant description may not be repeated hereinafter.

Referring to FIG. 1 and FIG. 17, the ramp driver 500 may include the ramp generator 510-2 for generating the reference ramp signal (RAMP_REF), and the ramp delayer 520 for sequentially outputting the reference ramp signal (RAMP_REF).

The ramp generator 510-2 may receive a ramp control signal (sel), an inverted ramp control signal (selb), a ramp selection signal (vfr), a high ramp voltage (VramH), and a gate voltage (Vgate), and may generate the reference ramp signal (RAMP_REF).

The ramp control signal (sel), the inverted ramp control signal (selb), and the ramp selection signal (vfr) may be included in the third control signal (CONT3). For example, the inverted ramp control signal (selb) may be a signal obtained by inverting the ramp control signal (sel).

In an embodiment, the high ramp voltage (VramH) may be provided from the outside of the display device to the ramp generator 510-2. For example, the high ramp voltage (VramH) may be provided from the power management integrated circuit to the ramp generator 510-2.

In another embodiment, the high ramp voltage (VramH) may be provided from the driving controller 200 or the power voltage generator inside the display device. For example, the driving controller 200 or the power voltage generator may receive a reference power voltage from the outside, and may generate the high ramp voltage (VramH) and the low ramp voltage (VramL).

The gate voltage (Vgate) will be described in more detail below.

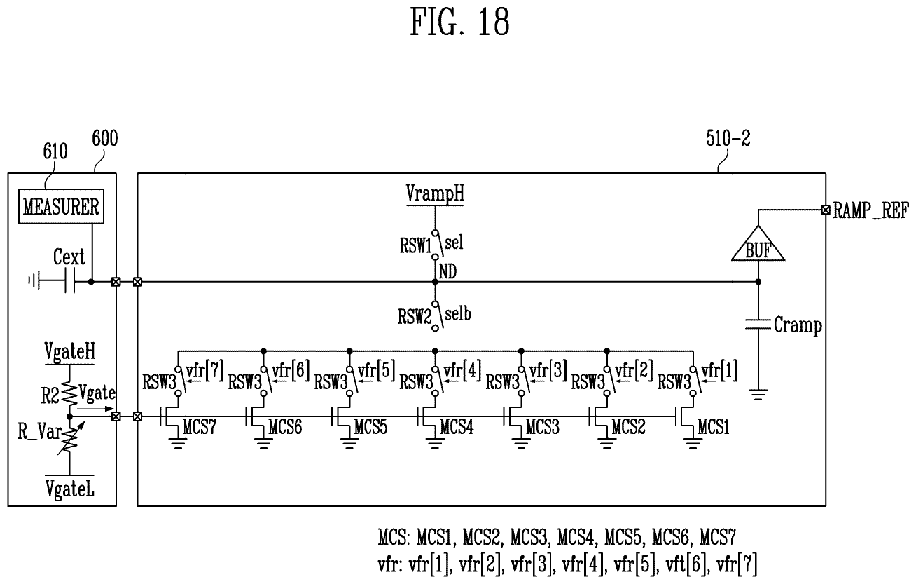

FIG. 18 is a block diagram illustrating an example of the ramp generator of FIG. 17.

Referring to FIG. 18, the ramp generator 510-2 may include ramp transistors (MCS), a first ramp switch (RSW1), a second ramp switch (RSW2), and third ramp switches (RSW3). The first ramp switch (RSW1) may be turned on in response to the ramp control signal (sel), and may include a first end applied with the high ramp voltage (VrampH), and a second end electrically connected to the output end of the ramp generator 510-2. The second ramp switch (RSW2) may be turned on in response to the inverted ramp control signal (selb), and may include a first end and a second end connected to the second end of the first ramp switch (RSW1). The third ramp switches (RSW3) may include a first end connected to the second end of the second ramp switch (RSW2), and a second end connected to one of the ramp transistors (MCS). The third ramp switches (RSW3) may be turned on in response to the ramp selection signal (vfr).

The ramp generator 510-2 may further include a buffer (BUF) disposed between a node (ND) connected with the second end of the first ramp switch (RSW1) and the output end of the ramp generator 510-2, and a ramp capacitor (Cramp) including a first electrode connected to the node (ND) and a second electrode that is grounded.

The display device may further include an external circuit 600. The external circuit 600 may include a measurer 610 for measuring a voltage of the node (ND), and an output capacitor (Cext) connected to the node (ND). The external circuit 600 may include a second resistor element (R2) including a first end that receives a high gate voltage (VgateH), and a second end connected to the control electrodes of the ramp transistors (MCS). A variable resistor element (R_Var) may include a first end connected to the control electrodes of the ramp transistors (MCS), and a second end that receives a low gate voltage (VgateL).

A voltage of the node (ND) may be charged to the output capacitor (Cext), and the measurer 610 may measure the voltage charged at the output capacitor (Cext). In an embodiment, the driving controller (e.g., 200 in FIG. 1) may regulate the high ramp voltage (VrampH) based on the measured voltage. In this case, the high ramp voltage (VrampH) may be provided from the driving controller 200 or the power voltage generator inside the display device. For example, the driving controller (e.g., 200 in FIG. 1) may increase the high ramp voltage (VrampH) if (e.g., when) the reference ramp signal (RAMP_REF) is lower than a target voltage, and may decrease the high ramp voltage (VrampH) if (e.g., when) the reference ramp signal (RAMP_REF) is higher than the target voltage. In another embodiment, an external device or a user of the display device may regulate the high ramp voltage (VrampH) based on the measured voltage.

The external circuit 600 may provide the gate voltage (Vgate) to the control electrodes of the ramp transistors (MCS). The gate voltage (Vgate) may be determined by a resistance value of the variable resistor element (R_Var), the high gate voltage (VgateH), and the low gate voltage (VgateL). The driving controller 200 or the user may regulate the gate voltage (Vgate) by adjusting the resistance value of the variable resistor element (R_Var), the high gate voltage (VgateH), and the low gate voltage (VgateL).

In an embodiment, the high gate voltage (VgateH) and the low gate voltage (VgateL) may be provided from the outside of the display device to the ramp generator 510-2. For example, the high gate voltage (VgateH) and the low gate voltage (VgateL) may be provided from the power management integrated circuit to the ramp generator 510-2.

In another embodiment, the high gate voltage (VgateH) and the low gate voltage (VgateL) may be provided from the driving controller 200 or the power voltage generator inside the display device. For example, the driving controller 200 or the power voltage generator may receive a reference power voltage from the outside, and may generate the high gate voltage (VgateH) and the low gate voltage (VgateL).

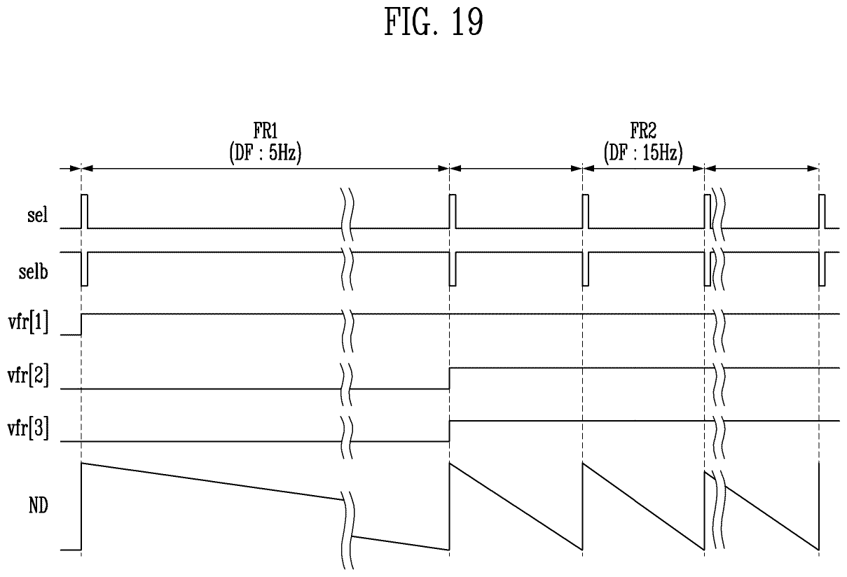

FIG. 19 is a timing diagram illustrating an example of driving the ramp generator of FIG. 18.

Referring to FIG. 18 and FIG. 19, if (e.g., when) the ramp control signal (sel) has the activation level, the first ramp switch (RSW1) may be turned on, and the high ramp voltage (VrampH) may be applied to the node (ND). If (e.g., when) the inverted ramp control signal (selb) has the activation level, the second ramp switch (RSW2) may be turned on, and at least one of the third ramp switches (RSW3) may be turned on. Accordingly, the voltage of the node (ND) may gradually decrease. Thus, the reference ramp signal (RAMP_REF) may be generated.

In an embodiment, a slope of the reference ramp signal (RAMP_REF) may increase as the number of the third ramp switches (RSW3) that are turned on increases. For example, as the number of the third ramp switches (RSW3) that are turned on increases, the voltage reduction of the node (ND) may be accelerated Thus, the slope of the reference ramp signal (RAMP_REF) may increase.

Depending on a length of each frame, the slope of the reference ramp signal (RAMP_REF) may be adjusted. For example, if (e.g., when) a driving frequency (DF) of a first frame (FR1) is 5 Hz, and the driving frequency (DF) of a second frame (FR2) is 15 Hz, only a first ramp selection signal (vfr[1]) may have the activation level in the first frame (FR1), and only first through third ramp selection signals (vfr[1] through vfr[3]) may have the activation level in the second frame (FR2).

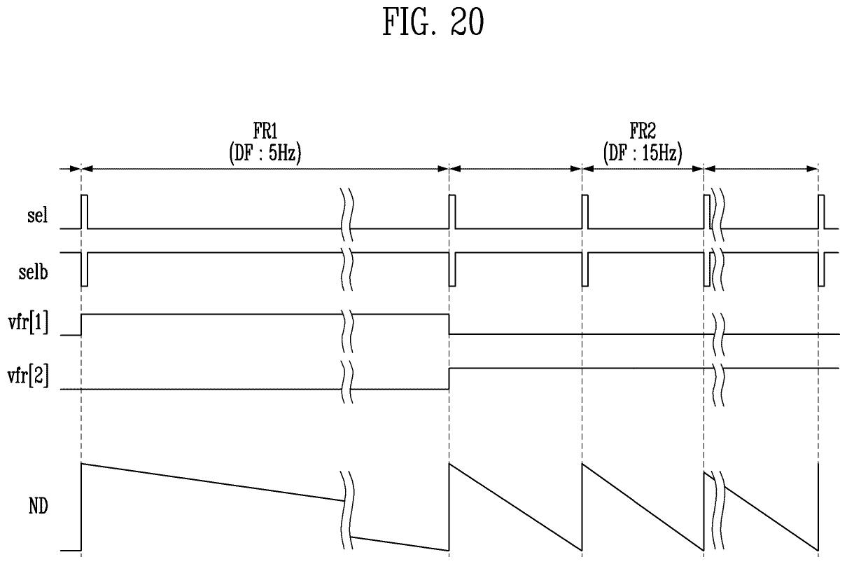

FIG. 20 is a timing diagram illustrating another example of driving the ramp generator of FIG. 18.

Referring to FIG. 18 and FIG. 20, the slope of the reference ramp signal (RAMP_REF) may vary depending on the third ramp switch (RSW3) that is turned on. A channel width of each of the third ramp switches (RSW3) may differ. For example, as the channel width of the ramp transistor (MCS) that is turned on increases, the slope of the reference ramp signal (RAMP_REF) may increase.

For example, if (e.g., when) the driving frequency (DF) of the first frame (FR1) is 5 Hz, the first ramp signal (vfr[1]) may have the activation level, and the first ramp transistor (MCS1) may be turned on in the first frame (FR1). For example, if (e.g., when) the driving frequency (DF) of the second frame (FR2) is 15 Hz, the second ramp signal (vfr[2]) may have the activation level in the second frame (FR2), and the second ramp transistor (MCS2) having the wider channel width than that of the first ramp transistor (MCS1) may be turned on.

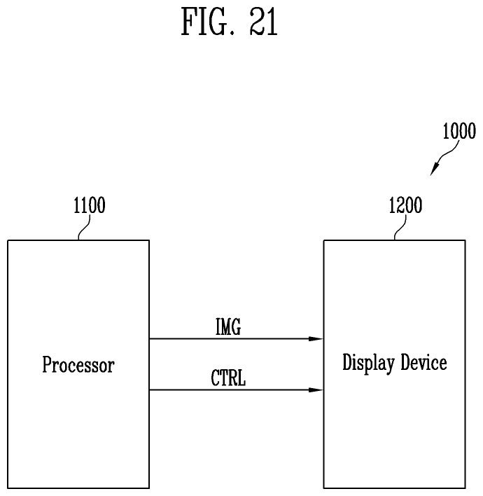

FIG. 21 is a block diagram illustrating an embodiment of a display system.

Referring to FIG. 21, a display system 1000 may include a processor 1100 and a display device 1200.

The processor 1100 may perform various suitable tasks and calculations. In some embodiments, the processor 1100 may include an application processor, a graphics processor, a microprocessor, a central processing unit (CPU), and/or the like. The processor 1100 may be connected to other components of the display system 1000 via a bus system to control them.

The processor 1100 may transmit image data (IMG) and a control signal (CTRL) to the display device 1200. The display device 1200 may display an image based on the image data (IMG) and the control signal (CTRL). The display device 1200 may be configured in the same manner as the display device (DD) described with reference to FIG. 1. In this case, the image data (IMG) and the control signal (CTRL) may be provided as the input image data (IMG) and the control signal (CTRL) of FIG. 1 respectively.

The display system 1000 may include a computing system for providing an image display function, such as a smart watch, a mobile phone, a smart phone, a portable computer, a tablet personal computer (PC), a watch phone, an automotive display, smart glasses, a portable multimedia player (PMP), navigation, or an ultra mobile personal computer (UMPC). In addition, the display system 1000 may include at least one of a head mounted display (HMD), a virtual reality (VR) device, a mixed reality (MR) device, or an augmented reality (AR) device.

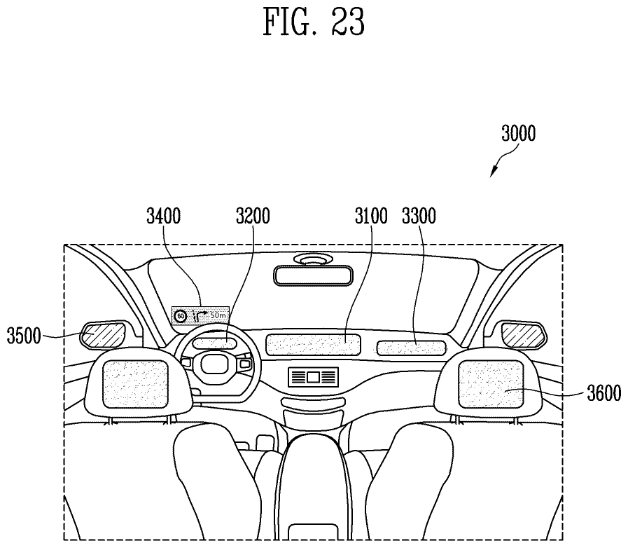

FIG. 23 through FIG. 25 are perspective views illustrating application examples of the display system of FIG. 21.

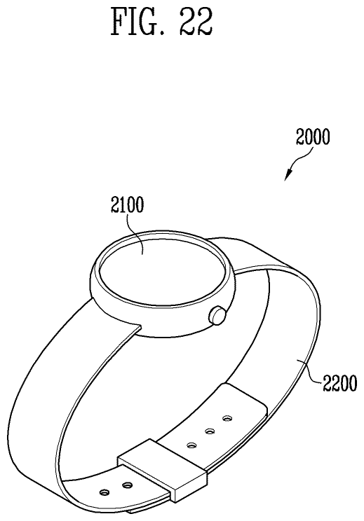

Referring to FIG. 22, the display system 1000 of FIG. 21 may be applied to a smart watch 2000 including a display part 2100 and a strap part 2200.

The smart watch 2000 may be a wearable electronic device. For example, the smart watch 2000 may have a structure in which the strap part 2200 is mounted on a user's wrist. Herein, the display system 1000 and/or the display device 1200 may be applied to the display part 2100, to provide image data including time information to the user.

Referring to FIG. 23, the display system 1000 of FIG. 21 may be applied to an automotive display system 3000. Herein, the automotive display system 3000 may include a computing system equipped inside and/or outside a vehicle to provide image data.

For example, the display system 1000 and/or the display 1200 may be applied to at least one of an infotainment panel 3100, a cluster 3200, a co-driver display 3300, a head-up display 3400, a side mirror display 3500, and/or a rear seat display 3600, which are provided in the vehicle.

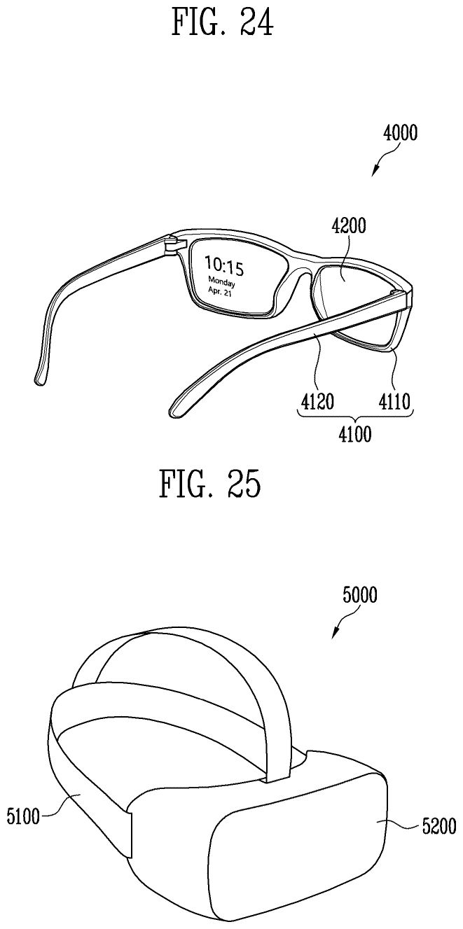

Referring to FIG. 24, the display system 1000 of FIG. 21 may be applied to smart glasses 4000. The smart glasses 4000 may be a wearable electronic device that may be worn on a user's head. For example, the smart glasses 4000 may be a wearable device for augmented reality.

The smart glasses 4000 may include a frame 4100 and a lens 4200. The frame 4100 may include a housing 4110 for supporting the lens 4200, and a temple 4120 for the user's wearing. The temple 4120 may be connected to the housing 4110 using a hinge, to be folded or unfolded with respect to the housing 4110.

The frame 4100 may include therein a battery, a touchpad, a microphone, a camera, and the like. In addition, the frame 4100 may include therein a projector for outputting light, a processor for controlling an optical signal, and the like.

The lens 4200 may include an optical member for transmitting light or reflecting light. For example, the lens 4200 may include glass, transparent synthetic resin, and the like.

For user's eyes to perceive visual information, the lens 4200 may reflect an image by an optical signal emitted from the projector of the frame 4100 to the back of the lens 4200 (e.g., a surface facing the user's eyes). For example, the user may recognize the visual information such as time and date displayed on the lens 4200. At this time, the projector and/or the lens 4200 may be a sort of the display device. The display device 1200 may be applied to the projector and/or the lens 4200.

Referring to FIG. 25, the display system 1000 of FIG. 21 may be applied to a head mounted display device 5000.

The head mounted display device 5000 may be a wearable electronic device that may be worn on the user's head. For example, the head mounted display device 5000 may be a wearable device for virtual reality or mixed reality.

The head mounted display device 5000 may include a head mounting band 5100 and a display device storage case 5200. The head mounting band 5100 may be connected to the display device storage case 5200. The head mounting band 5100 may include a horizontal band and/or a vertical band for fixing the head mounted display device 5000 onto the user's head. The horizontal band may be configured to surround a side part of the user's head, and the vertical band may be configured to surround an upper part of the user's head. However, embodiments are not limited thereto. For example, the head mounting band 5100 may be implemented in a glasses frame form, a helmet form, and the like.

The display device storage case 5200 may accommodate the display system 1000 and/or the display device 1200.

A ramp driver according to some embodiments of the present disclosure may generate a ramp signal for driving a subpixel in a pulse width modulation (PWM) manner through a resistor string.

The ramp driver according to some embodiments of the present disclosure may generate the ramp signal for driving the subpixel in the PWM manner through a ramp transistor.

However, the aspects and features of the present disclosure are not limited to those described above, and may be variously expanded as would be understood by those having ordinary skill in the art.

Although some embodiments and applications have been described herein, which are provided merely to help more general understanding of the present disclosure, the present disclosure is not limited the above embodiments, and those having ordinary knowledge in the art may understand how to make various changes and modifications therefrom.

Some embodiments of the present disclosure may be applied to a display device and an electronic device including the same. For example, some embodiments of the present disclosure may be applied to a digital television (TV), a three-dimensional (3D) TV, a mobile phone, a smart phone, a tablet computer, a VR device, a personal computer, a home electronic device, a notebook computer, a personal digital assistant (PDA), a portable media player (PMP), a digital camera, a music player, a portable game console, a navigation, and the like.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A ramp driver comprising:
a ramp generator configured to generate a reference ramp signal, and comprising a resistor string comprising:
a first end configured to receive a high ramp voltage; and
a second end configured to receive a low ramp voltage; and
a ramp delayer configured to sequentially output the reference ramp signal,
wherein the ramp generator is configured to:
divide the high ramp voltage into first through k-th voltages by utilizing the resistor string; and
sequentially output the first through k-th voltages to generate the reference ramp signal, where k is a positive integer.

2. The ramp driver according to claim 1, wherein the ramp generator further comprises a plurality of stages, each of the stages configured to output at least one of the first through k-th voltages, and comprising:
at least one resistor element of a plurality of resistor elements included in the resistor string;
a ramp switch configured to be turned on in response to a ramp control signal, and comprising a first end connected to the at least one resistor element, and a second end connected to an output end of the ramp generator; and
a flip-flop configured to output the ramp control signal.

3. The ramp driver according to claim 2, wherein the flip-flop of a first stage of the plurality of stages is configured to receive a vertical start signal, and
wherein the flip-flop of a second stage of the plurality of stages is configured to receive the ramp control signal output from the flip-flop of the first stage.

4. The ramp driver according to claim 1, wherein the ramp delayer comprises a plurality of delay blocks, each comprising j output ends, where j is a positive integer greater than or equal to 2.

5. The ramp driver according to claim 4, wherein each of the delay blocks comprises j delay circuits configured to delay an input signal,
a first delay circuit of the delay circuits of a first delay block among the delay blocks is configured to receive the reference ramp signal, and
a second delay block of the delay blocks is configured to receive an output signal of a j-th delay circuit of the delay circuits of the first delay block.

6. The ramp driver according to claim 5, wherein at least one of the delay circuits comprises:
a first amplifier comprising a first input end, a second input end, and an output end connected to the second input end;
a first delay switch configured to be turned on in response to a gate clock signal, and comprising a first end connected to an input end of the at least one of the delay circuits, and a second end connected to the first input end of the first amplifier;
a second delay switch configured to be turned on in response to the gate clock signal, and comprising a first end and a second end connected to the second input end of the first amplifier;
a sampling capacitor comprising a first electrode connected to the first input end of the first amplifier, and a second electrode connected to the first end of the second delay switch;
a third delay switch configured to be turned on in response to an inverted gate clock signal, and comprising a first end connected to the input end of the at least one of the delay circuits, and a second end connected to the second electrode of the sampling capacitor; and
a fourth delay switch configured to be turned on in response to the inverted gate clock signal, and comprising a first end connected to the output end of the first amplifier, and a second end connected to an output end of the at least one of the delay circuits.

7. The ramp driver according to claim 6, wherein the at least one of the delayed circuits further comprises a fifth delay switch configured to be turned on in response to the inverted gate clock signal, and comprising a first electrode connected to the first input end of the first amplifier, and a second electrode connected to the first input end of the first amplifier.

8. The ramp driver according to claim 6, wherein the gate clock signal has an activation level in a sampling period, and has an inactivation voltage level in an output period, and
the inverted gate clock signal has an inactivation level in the sampling period, and has an activation level in the output period.

9. The ramp driver according to claim 4, wherein each of the delay blocks comprises:
j delay circuits for delaying an input signal; and
an error compensator configured to generate a compensation control signal by comparing an output signal of a first delay circuit of the delay circuits and an output signal of a j-th delay circuit of the delay circuits.

10. The ramp driver according to claim 9, wherein the error compensator comprises:
a second amplifier comprising a first input end, a second input end configured to receive a reference voltage, and an output end;
a first capacitor comprising a first electrode and a second electrode connected to the first input end of the second amplifier;
a second capacitor comprising a first electrode connected to the first input end of the second amplifier, and a second electrode connected to the output end of the second amplifier;
a sixth delay switch configured to be turned on in response to a compensation clock signal, and comprising a first end connected to the first input end of the second amplifier, and a second end connected to the output end of the second amplifier;
a seventh delay switch configured to be turned on in response to an inverted compensation clock signal, and comprising a first end connected to a first input end of the error compensator, and a second end connected to the first electrode of the first capacitor;
an eighth delay switch configured to be turned on in response to the compensation clock signal, and comprising a first end connected to a second input end of the error compensator, and a second end connected to the first electrode of the first capacitor;
a ninth delay switch configured to be turned on in response to a gate clock signal, and comprising a first end connected to the output end of the second amplifier, and a second end connected to an output end of the error compensator;
a comparator configured to compare a signal of the first input end of the error compensator and a signal of the second input end of the error compensator to output a comparison signal;
a first delay transistor comprising a control electrode configured to receive the comparison signal, a first electrode configured to receive a first predicted voltage, and a second electrode;
a second delay transistor comprising a control electrode configured to receive the comparison signal, a first electrode configured to receive a second predicted voltage different from the first predicted voltage, and a second electrode; and
a tenth delay switch configured to be turned on in response to an inverted gate clock signal, and comprising a first end connected to the second electrode of the first delay transistor and the second electrode of the second delay transistor, and a second end connected to the output end of the error compensator.

11. The ramp driver according to claim 10, wherein the first delay transistor is of a different type from that of the second delay transistor.

12. The ramp driver according to claim 9, wherein a first delay block of the delay blocks is configured to generate the compensation control signal, and apply the compensation control signal to a second delay block of the delay blocks, and
the first delay circuit of the second delay block is configured to receive the output signal of the j-th delay circuit of the first delay block, and compensate for the output signal of the j-th delay circuit of the first delay block in response to the compensation control signal received from the first delay block.

13. The ramp driver according to claim 12, wherein the first delay circuit of the second delay block comprises:
a first amplifier comprising a first input end, a second input end, and an output end connected to the second input end;
a first delay switch configured to be turned on in response to a gate clock signal, and comprising a first end connected to an input end of the first delay circuit of the second delay block, and a second end connected to the first input end of the first amplifier; and
a sampling capacitor comprising a first electrode connected to the first input end of the first amplifier, and a second electrode configured to receive the compensation control signal.

14. The ramp driver according to claim 13, wherein the compensation control signal alternately has a difference of a voltage of the first input end of the error compensator and a voltage of the second input end of the error compensator and a second predicted voltage in a first period, and
alternately has a difference of a voltage of the first input end of the error compensator and a voltage of the second input end of the error compensator and the first predicted voltage in a second period.

15. A ramp driver comprising:
a ramp generator configured to generate a reference ramp signal; and
a ramp delayer configured to sequentially output the reference ramp signal,
wherein the ramp generator comprises:
a plurality of ramp transistors;
a first ramp switch configured to be turned on in response to a ramp control signal, and comprising a first end configured to receive a high ramp voltage, and a second end electrically connected to an output end of the ramp generator;
a second ramp switch configured to be turned on in response to an inverted ramp control signal, and comprising a first end connected to the second end of the first ramp switch, and a second end; and
a plurality of third ramp switches, each comprising a first end connected to the second end of the second ramp switch, and a second end connected to one of the ramp transistors.

16. The ramp driver according to claim 15, wherein a slope of the reference ramp signal increases as a channel width of each of the third ramp switches that are turned on increases.

17. The ramp driver according to claim 15, wherein a channel width of each of the ramp transistors are different from each other,
the reference ramp signal has a first slope, when a first ramp transistor of the ramp transistors is turned on, and
the reference ramp signal has a second slope greater than the first slope, when a second ramp transistor having the channel width greater than that of the first ramp transistor among the ramp transistors is turned on.

18. A wearable electronic device, comprising:
a processor;
a first display device configured to provide an image to a user's right eye; and
a second display device configured to provide an image to the user's left eye,
wherein at least one of the first display device or the second display device comprises:
a ramp generator configured to generate a reference ramp signal, and comprising a resistor string comprising:
a first end configured to receive a high ramp voltage; and
a second end configured to receive a low ramp voltage; and
a ramp delayer configured to sequentially output the reference ramp signal,
wherein the ramp generator is configured to:
divide the high ramp voltage into first through k-th voltages by utilizing the resistor string; and
sequentially output the first through k-th voltages to generate the reference ramp signal, where k is a positive integer, and
wherein the wearable electronic device comprises at least one of a head mounted display (HMD) device, a virtual reality (VR) device, a mixed reality (MR) device, or an augmented reality (AR) device.

19. The wearable device of claim 18, wherein the ramp generator further comprises a plurality of stages, each of the stages configured to output at least one of the first through k-th voltages, and comprising:
at least one resistor element of a plurality of resistor elements included in the resistor string;
a ramp switch configured to be turned on in response to a ramp control signal, and comprising a first end connected to the at least one resistor element, and a second end connected to an output end of the ramp generator; and
a flip-flop configured to output the ramp control signal.

20. The wearable device of claim 19, wherein the flip-flop of a first stage of the plurality of stages is configured to receive a vertical start signal, and
wherein the flip-flop of a second stage of the plurality of stages is configured to receive the ramp control signal output from the flip-flop of the first stage.
